(19) United States
(12) Patent Application Publication
(10) Pub. No.: US 2024/0312441 A1
(43) Pub. Date: Sep. 19, 2024

(54) MACHINE LEARNING ASSISTED MUSIC VISUALIZATION

(71) Applicant: Adam Hilss, Austin, TX (US)

(72) Inventor: Adam Hilss, Austin, TX (US)

(21) Appl. No.: 18/603,084

(22) Filed: Mar. 12, 2024

Related U.S. Application Data
(60) Provisional application No. 63/452,115, filed on Mar. 14, 2023.

(51) Int. Cl. G10H 1/00

(52) U.S. Cl. CPC G10H 1/0008; G10H 2220/005

(57) ABSTRACT

Devices, methods, and other aspects are provided for compact visual representation of song data. A device may receive an indication of a first song selection from a song data listing, receive processed stem data associated with the first song selection, wherein the processed stem data is generated from first song music data processed by a machine learning source separation model, and dynamically generate first song frequency indicators and first song amplitude indicators from the processed stem data for times from a start to an end of the first song music data. The device may dynamically display the first song amplitude indicators in a timing window of a user interface in various ways in accordance with aspects described.

### CROSS-REFERENCE TO RELATED APPLICATIONS

The present application claims the priority benefit of U.S. Provisional Patent Application No. 63/452,115 filed on Mar. 14, 2023 and titled “MACHINE LEARNING ASSISTED MUSIC VISUALIZATION”, the disclosure of which is hereby incorporated by reference in its entirety for all purposes.

### FIELD

The present disclosure relates generally to music processing and visualization. More specifically, devices and techniques are provided to dynamically process stems generated from machine learning source separation models to generate compact visual representation of music, which can assist with further mixing or music processing.

### BACKGROUND

Aspects described herein related to music analysis, and visual representation and manipulation of song data to create compact and efficient representations of songs while providing detailed visual information about the structure and content of a song.

In some aspects, the techniques described herein relate to a computer-implemented method including: receiving music stem data associated with song data, wherein the music stem data includes first track data from a plurality of data tracks of the song data, and wherein the first track data is extracted from the music stem data using a machine learning source separation model; processing the music stem data to estimate at least one fundamental frequency associated with the music stem data; processing the music stem data to calculate amplitudes associated with the music stem data for time segments of the music stem data; and facilitating generation of a visual representation of the music stem data using the at least one fundamental frequency and the amplitudes associated with the music stem data for the time segments of the music stem data.

In some aspects, the techniques described herein relate to a system including: a memory configured to store music stem data associated with song data; and one or more processors coupled to the memory and configured to perform operations including: receiving the music stem data associated with the song data, wherein the music stem data includes first track data from a plurality of data tracks of the song data, and wherein the first track data is extracted from the music stem data using a machine learning source separation model; processing the music stem data to estimate at least one fundamental frequency associated with the music stem data; processing the music stem data to calculate amplitudes associated with the music stem data for time segments of the music stem data; and facilitating generation of a visual representation of the music stem data using the at least one fundamental frequency and the amplitudes associated with the music stem data for the time segments of the music stem data.

In some aspects, the techniques described herein relate to a non-transitory computer readable storage medium including instructions that, when executed by one or more processors of a device, cause the device to perform operations including: receiving music stem data associated with song data, wherein the music stem data includes first track data from a plurality of data tracks of the song data, and wherein the first track data is extracted from the music stem data using a machine learning source separation model; processing the music stem data to estimate at least one fundamental frequency associated with the music stem data; processing the music stem data to calculate amplitudes associated with the music stem data for time segments of the music stem data; and facilitating generation of a visual representation of the music stem data using the at least one fundamental frequency and the amplitudes associated with the music stem data for the time segments of the music stem data.

In some aspects, the techniques described herein relate to a computing device including a display screen, the computing device being configured to display on the screen a compact representation of a song, the compact representation of the song including a representation of a stem of the song generated by processing song data for the song using a machine learning source separation model to generate the stem, processing the stem to determine one or more frequencies and associated amplitudes for the stem at time periods from a start to an end of the song, and dynamically generating the compact representation of the song including a stem visualization within a detail window of a user interface presented on the screen.

In some aspects, the techniques described herein relate to a computing device including a display screen, the computing device being configured to display on the screen a compact representation of a song, the compact representation of the song including a representation of a percussion stem of the song generated by processing song data for the song using a machine learning source separation model to generate the percussion stem, processing the percussion stem using one or more of a drum transcription model, a filter, and an amplitude envelope detector to generate discrete indicators associated with the percussion stem, and dynamically generating the compact representation of the song including the discrete indicators within a detail window of a user interface presented on the screen.

In some aspects, the techniques described herein relate to a computer-implemented method including: receiving an indication of a first song selection from a song data listing; receiving processed stem data associated with the first song selection, wherein the processed stem data is generated from first song music data processed by a machine learning source separation model; dynamically generating first song frequency indicators and first song amplitude indicators from the processed stem data for times from a start to an end of the first song music data; and dynamically displaying the first song amplitude indicators in a timing window of a user interface.

### BRIEF DESCRIPTION OF THE DRAWINGS

FIG. 1 illustrates aspects of a machine learning source separation model for use with aspects described herein.

FIG. 2 illustrates aspects of music stem data processing and visualization in accordance with aspects described herein.

FIG. 3A illustrates aspects of music stem data visualization in accordance with aspects described herein.

FIG. 3B illustrates aspects of music stem data visualization in accordance with aspects described herein.

FIG. 4 illustrates aspects of percussion stem data processing and visualization with discrete indicators in accordance with aspects described herein.

FIG. 5A illustrates aspects of percussion stem data processing and visualization with discrete indicators in accordance with aspects described herein.

FIG. 5B illustrates aspects of percussion stem data processing and visualization with discrete indicators in accordance with aspects described herein.

FIG. 6 illustrates aspects of a system for stem generation, processing, and visualization in accordance with aspects described herein.

FIG. 7A illustrates aspects of compact music stem data visualization in accordance with aspects described herein.

FIG. 7B illustrates aspects of compact music stem data visualization in accordance with aspects described herein.

FIG. 8 illustrates aspects of a user interface for compact music stem data visualization in accordance with aspects described herein.

FIG. 9A illustrates aspects of a user interface for music processing and mixing with compact music stem data visualization in accordance with aspects described herein.

FIG. 9B illustrates aspects of a user interface for music processing and mixing with compact music stem data visualization in accordance with aspects described herein.

FIG. 9C illustrates aspects of a user interface for music processing and mixing with compact music stem data visualization in accordance with aspects described herein.

FIG. 9D illustrates aspects of a user interface for music processing and mixing with compact music stem data visualization in accordance with aspects described herein.

FIG. 9E illustrates aspects of a user interface for music processing and mixing with compact music stem data visualization in accordance with aspects described herein.

FIG. 9F illustrates aspects of a user interface for music processing and mixing with compact music stem data visualization in accordance with aspects described herein.

FIG. 9G illustrates aspects of a user interface for music processing and mixing with compact music stem data visualization in accordance with aspects described herein.

FIG. 9H illustrates aspects of a user interface for music processing and mixing with compact music stem data visualization in accordance with aspects described herein.

FIG. 10A illustrates aspects of a user interface for music processing and mixing with compact music stem data visualization in accordance with aspects described herein.

FIG. 10B illustrates aspects of a user interface for music processing and mixing with compact music stem data visualization in accordance with aspects described herein.

FIG. 10C illustrates aspects of a user interface for music processing and mixing with compact music stem data visualization in accordance with aspects described herein.

FIG. 10D illustrates aspects of a user interface for music processing and mixing with compact music stem data visualization in accordance with aspects described herein.

FIG. 10E illustrates aspects of a user interface for music processing and mixing with compact music stem data visualization in accordance with aspects described herein.

FIG. 11A illustrates aspects of compact music stem data visualization in accordance with aspects described herein.

FIG. 11B illustrates aspects of compact music stem data visualization in accordance with aspects described herein.

FIG. 12 is a method for implementing a compact music stem data visualization in accordance with aspects described herein.

FIG. 13 is a method for implementing a compact music stem data visualization in accordance with aspects described herein.

FIG. 14 is a method for implementing a compact music stem data visualization in accordance with aspects described herein.

FIG. 15 illustrates a computing system that can be used to implement compact music stem data visualization in accordance with aspects described herein.

FIG. 16 illustrates a networked computing system that can be used to implement compact music stem data visualization in accordance with aspects described herein.

### DESCRIPTION

Aspects described herein include systems and methods for computer-implemented automatic visualization of musical structures generated from audio recording data. Examples are described below for the purpose of illustrating implementations. It will be apparent that additional examples not specifically described are possible given the details provided below. The description provides examples, and the scope of the claimed invention is intended to be represented by the claims as supported by the following description.

As described herein, a stem is a component of song data. A stem is typically associated with an instrument (e.g., which can be a pitched instrument or an unpitched instrument), or a group of instruments with similar characteristics. For example, a traditional rock quartet recording would include four stems, a guitar stem, a bass stem, a vocal stem, and a percussion (e.g., drum set) stem. Different stem organization can, in some implementations, group multiple instruments (e.g., multiple voices, multiple guitars, an orchestra section, etc.) into a single stem rather than isolating individual instruments. In some aspects, one stem can represent a single aspect of a song (e.g., vocals) with another stem representing everything but the aspect represented in the stem (e.g., everything but the vocals). Similarly, some aspects can include stems for specific portions of music (e.g., vocals, guitar, drums, bass, etc.), with all remaining components not having a separate stem grouped into a single stem for the remaining components.

Disk Jockeys (DJs) mix music in real time with a variety of tools. Historical use of vinyl records has largely been replaced with digital tools that allow real-time dynamic transitions and mixing using digital computing devices and digital music files. DJ tools can include systems to generate visual representations of song data (e.g., visual representations of waveforms representing audio recording data). Such visualizations usually provide information about an amplitude envelope of the audio signal from simple frequency waveforms of the song data. Such waveforms convey a limited amount of musical information, which necessitates that a DJ prepare cue points and pre-cue song data prior to live mixing, but have the benefit of requiring limited processing power to generate the waveforms.

The advent of artificial intelligence, machine learning, and improving computing systems has led to the development of music source separation technologies that enable separation of song data (e.g., a digital audio recording, a raw audio recording, pulse-code modulation (PCM) data, etc.) into stems when the song data does not include any cues or information (e.g., musical score information, musical instrument digital interface (MIDI) cues or data, etc.) about the stems. While some aspects can use such additional cues or information or operate when such additional information is present, other aspects do not include any such additional cues or information. Aspects described herein can use stem data for one or more songs generated using machine learning source separation modes, to generate compact visual representations of the song data. Presentation of such compact visual representations of one or more songs in a user interface as described herein improves the operation of computing devices by enabling improved on-the-fly mixing. Such improved computing devices provide DJs with additional song information that can allow mixing with limited or no pre-preparation of cue points, reducing the user time needed to perform similar mixing operations.

Aspects described herein solve the problem of limited information that can be identified from waveform data by providing a specific structured graphical user interface. Aspects further allow the improved stem visual representation for multiple songs to be positioned in a compact representation with synchronized timing to further improve the ability for users to identify key mixing information and to facilitate real-time mixing using the additional information provided within the graphic user interface in a way not possible using prior waveform representation interfaces.

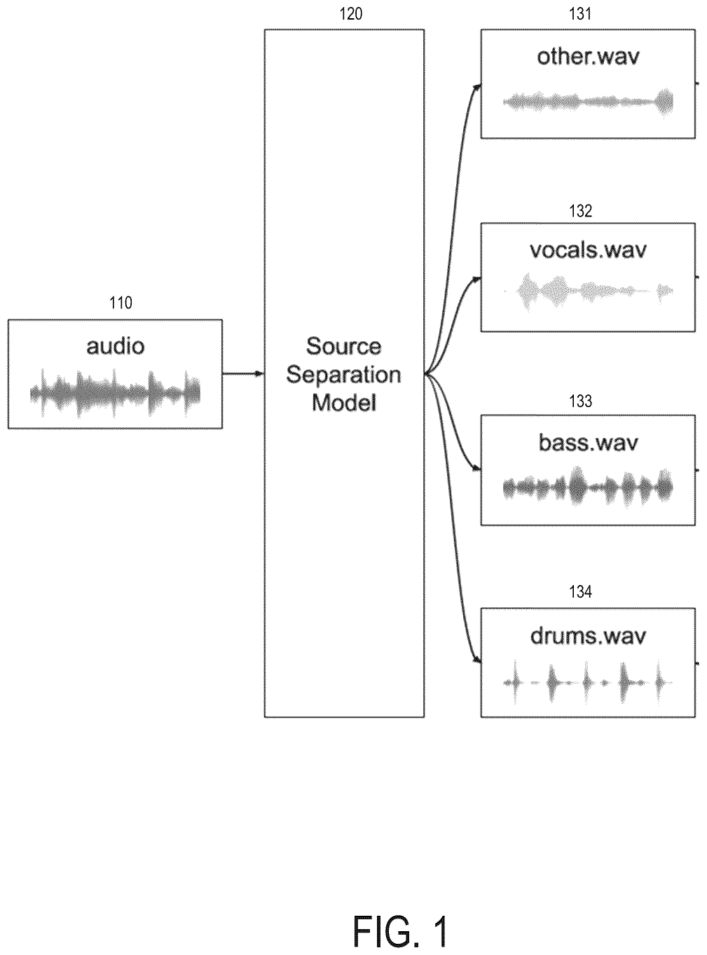

FIG. 1 illustrates the use of a source separation model 120 to generate music stem data 131, 132, 133, 134 from audio data 110 (e.g., song data). Examples of the source separation model 120 include Spleeter™ from Deezer Research™, Demucs™ from Facebook™ research, or other such source separation models. Such source separation models 120 can, for example, be trained by providing song data inputs and stem data training outputs to a machine learning system using, for example, the Tensorflow™ machine learning platform. By training a model using such training data, the model can be trained to accept digital song data (e.g., a digital audio file) as an input, and create separate stem data outputs.

The audio data 110 and the stem data 131, 132, 133, and 134 are all music data, as illustrated by the associated waveform data shown at the input and outputs of the source separation model 120. Waveform visualizations as shown for the audio data 110 and the stem data 131, 132, 133, 134 is represented by symmetrical amplitudes around a horizontal timeline, with each position in the timeline representing a position or time within music data, from a start point at the start of a song, to an end point at an end of the song associated with the audio data 110. Such waveform visualizations as described above are not compact, and in isolation provide limited information about a song or portions (e.g., stems or instrument tracks or groupings) that combine to make a song. Aspects described herein can use stem data 131, 132, 133, 134 from audio data 110 to generate compact visualizations that can improve the operation of devices and systems for mixing and providing DJ tools.

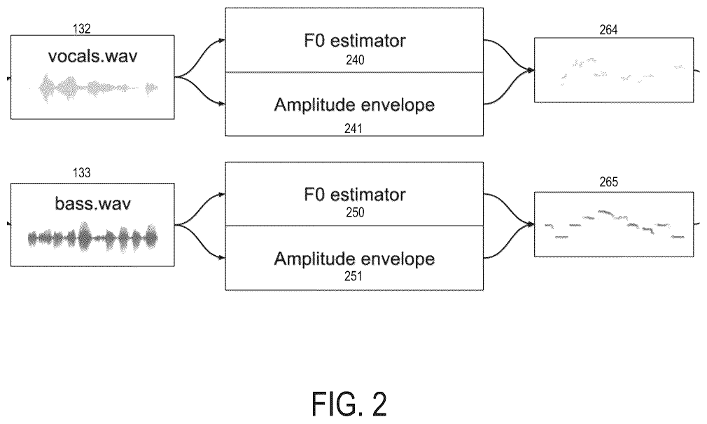

FIG. 2 illustrates aspects of music stem data processing and visualization in accordance with aspects described herein. FIG. 2 illustrates systems and operations for processing stem data received from an output of a source separation model (e.g., the source separation model 120) as described above. FIG. 2 includes stem data 132 associated with a vocal stem, stem data 133 associated with a bass stem, and systems for processing such stem data. The processing systems of FIG. 2 include dominant fundamental frequency (f0) estimators 240, 250, and amplitude envelope calculators 241, 251.

The dominant fundamental frequency of music data or stem data is a musical note that is identified as the lowest simple tone (e.g., audible frequency or partial) present in the waveform at a particular time position. While other lower audible frequencies can be present in the data, the dominant fundamental can be identified by the f0 estimators 240, 250 from the waveforms indicated by stem data. Such f0 estimators can be implemented using tools such as HarmoF0™ DeepF0™, or CREPE™. FIG. 2 represents f0 estimates 240, 250 as separate, but in some aspects, the same system can be used to determine f0 values from multiple input stems.

Amplitude envelope calculators 241, 251 determine an amplitude associated with time positions within a stem. Such amplitude envelope calculators can perform computations using a long-amplitude envelope of stem audio signals normalized by a maximum signal amplitude. In other aspects, other envelope calculation and normalization methods can be used. The amplitudes are associated with greater or lesser volumes for the sounds of each stem. In some implementations, a stem can have multiple f0 values, such as multiple frequencies from a chord, when a stem includes information from multiple instruments creating sound with different f0 characteristics, or in certain complex musical arrangements. In some aspects, an f0 estimator such as the f0 estimators 240, 250 can indicate the presence of multiple f0 values, or can use selected criteria to identify one value from the possible values, depending on the implementation.

The combination of an f0 value and a calculated envelope amplitude for each time position can then be used to generate a compact visual representation of a stem. In FIG. 2, the compact visual representation 264 associated with the stem data 132 includes an amplitude representation in a simple point representation for each time position, instead of the waveform representation associated with the stem data 132. The compact visual representation 265 similarly includes amplitude and position data without scaling information or a reference graph in the display that would clutter the presented information.

The compact visual representations can include note segmentation using various heuristics. In one implementation, samples are processed in chronological order, with an active set of notes maintained at each time having associated samples. At each time or frequency, a sample is either filtered if below a threshold, appended to an existing note from an active sample set, or added to an active set as a new note. After each time step, a note is considered finalized if it was not extended with a new sample. If a note is less than a minimum duration, the note is dropped, otherwise the note is persisted and maintained for inclusion in the visual representation.

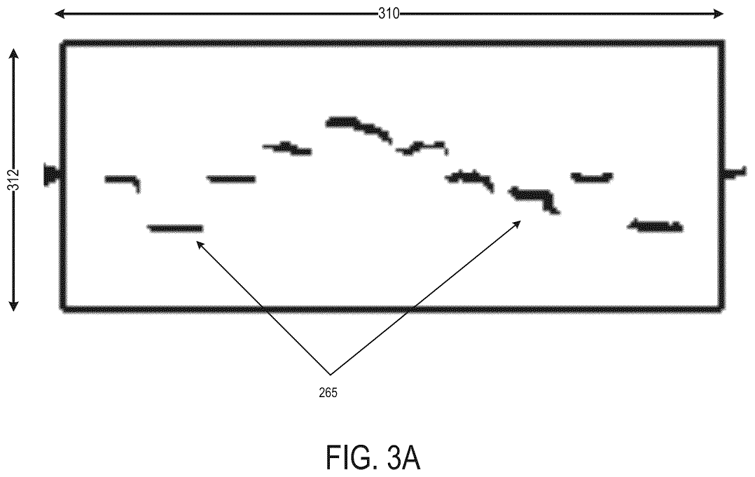

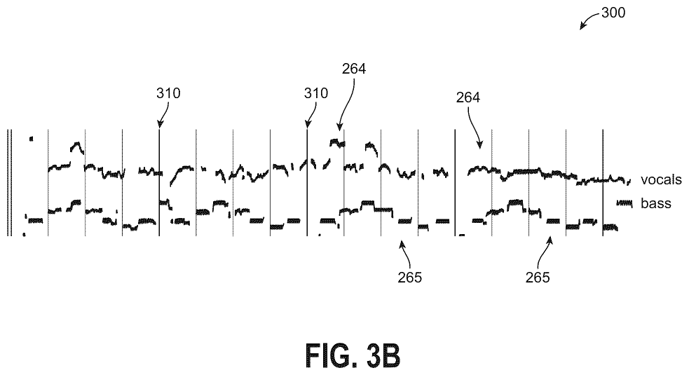

FIG. 3A illustrates aspects of music stem data visualization in accordance with aspects described herein. FIG. 3A illustrates a close-up representation of a time period 310 of the compact visual representation 265. The vertical position 312 of the stem data at a position within the time period 310 indicates a greater frequency for a higher position, and a lower frequency for a lower position (e.g., changes in the notes or primary tones for a stem), with the horizontal position representing a time position within the time period 310 of a song. If multiple significant frequencies are present, each can be represented by a separate line. As illustrated, the compact visual representation 265 allows multiple stems from audio data of a first song to be represented alongside representations from another song to allow improved information presentation of a large amount of data when compared with waveform visual representations. The simple point presentation against time position also provides key information to a user, describing relative notes at a given point in audio data while avoiding the user interface space required to indicate an exact note (e.g., frequency), which is less important information for real-time on-the-fly mixing. Also, by representing multiple tones (e.g., from a chord) as separate lines, the complexity within each stem can be represented in a compact form, and transitions from single note dominance to chord presence can be visualized by the presence of single or multiple lines within a stem lane.

In some aspects, the scaling of the vertical position can be performed by calculating a mean and standard deviation for the frequencies present in a stem, and scaling each stem against these values. In some aspects, logarithmic scaling away from the mean value can be used. In other aspects, linear scaling can be used. The use of colors for different stems can be used to distinguish between stems, particularly if stems with a wide frequency range are allowed to be positioned in the lane of adjacent stems (e.g., when a stem has some notes far outside of the mean and standard deviation of the stem). In other aspects, vertical positioning can be scaled to multiple standard deviations or clipped to prevent information from an adjacent stem from being obscured.

In some aspects, characteristics of a line within a compact visual representation can be used to indicate a volume of the stem. Such characteristics can include color brightness (e.g., when stems have a specific associated color), line thickness, color variation (e.g., with certain colors assigned to greater volume values), or other such characteristics. In some such aspects, when multiple tones are present (e.g., multiple lines are present for a given time position or time segment), a shared overall volume for the stem can be assigned to all the lines. In other aspects, fast Fourier transform analysis can be used to determine the volume for each tone, and can represent the volume of each tone (e.g., the different note or f0 combinations in a stem) separately.

FIG. 3B illustrates aspects of music stem data visualization 300 in accordance with aspects described herein, including the compact visual representation 264 and the compact visual representation 265 in a shared space, with time segments indicating positions along the time period 310 of the music data for the song. The simple point presentation against time position (e.g., which is compact compared to the waveform presentation) allows compact visual representations 264, 265 to be positioned in a shared space while providing the key relative frequency movement occurring within the music to a user.

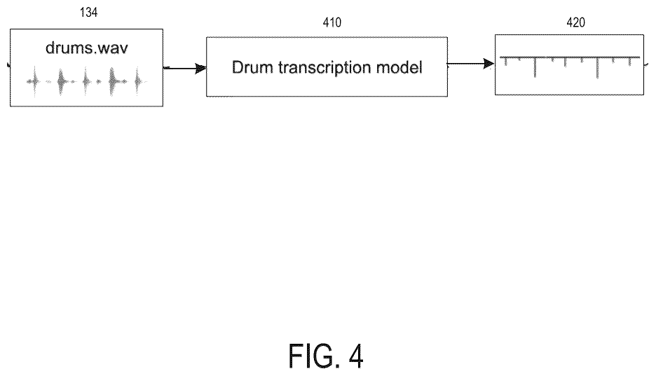

FIG. 4 illustrates aspects of percussion stem data processing and visualization with discrete indicators in accordance with aspects described herein. The f0 of the percussion is typically not relevant information for mixing, and the envelope information is not well represented by the point model shown in FIGS. 3A and 3B due to the brief percussive nature of the sounds and associated audio data. Because of the nature of the percussion sounds, and the goal of a compact visual representation, discrete indicators 420 can be used in place of fine point or graphed visualizations (e.g., used in FIGS. 3A and 3B). Such discrete indicators 420 can be generated by a drum transcription model 410, which can be a machine learning model that generates information about timing and rhythm information present within a percussion stem. As illustrated in FIG. 4, such a drum transcription model 410 can receive a percussion stem data 134 and output discrete indicators 420, where the discrete indicators include a thin vertical line at a primary position relative to the timing of a song (e.g., with discrete lines positioned on or off the beat, and the length of the discrete vertical line representing the volume of the stem data at a time position). The discrete representation allows for compact visualization while conveying key percussion information from the percussion stem.

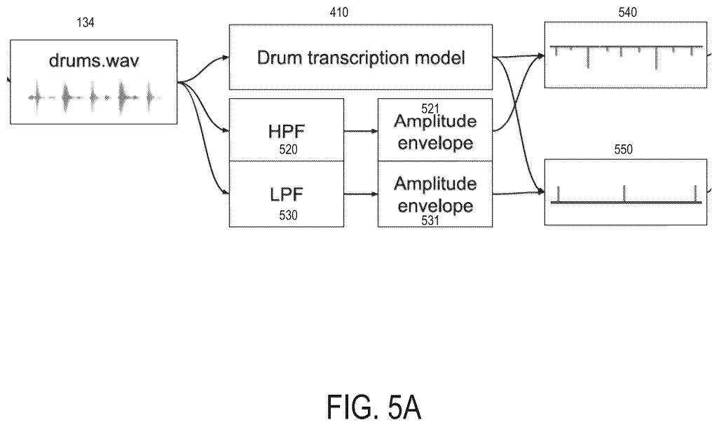

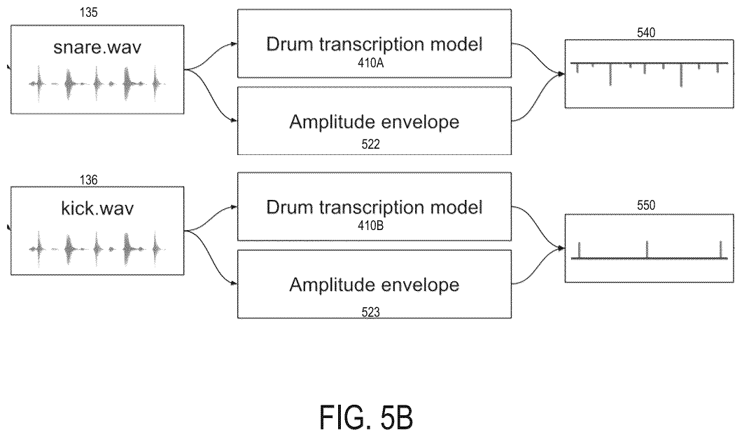

FIG. 5A illustrates aspects of percussion stem data processing and visualization with discrete indicators in accordance with aspects described herein. The drum transcription model 410 of FIG. 4 reflects a simple view of percussion which may function for certain types of music data, but not for others. In some aspects, for example, high frequency percussion and/or low frequency percussion may obscure the presence of each other in a compact representation which includes only a drum transcription model 410. FIG. 5A includes both a drum transcription model analysis 410 of the percussion stem 134, as well as filtered analysis. The signal from the percussion data 134 can be copied into the drum transcription model 410, a high pass filter 520, and a low pass filter 530. The high pass filter can generate a filtered output passed to an amplitude envelope calculator, and used to emphasize high frequency percussion data in discrete indicators 540. The low pass filter 530 can pass a low frequency percussion signal to amplitude envelope calculator 531 (e.g., which may be the same or a different calculator from the amplitude envelope calculator 521). An output of the amplitude envelope calculator 531 using the low frequency percussion data can generate low frequency discrete indicators 550. Such separation of the high frequency percussion from the low frequency percussion can provide key rhythm information to a DJ performing real-time on-the-fly mixing, while maintaining a compact representation that allows complex stem data from instruments to occupy a user interface with the discrete indicators 540, 550. In some aspects, a high pass filter 520 can pass hi-hat, cymbal, and snare drum percussive audio, while a low frequency filter 530 can pass kick and/or bass drum percussive audio.

FIG. 5B illustrates additional aspects of percussion stem data processing and visualization with discrete indicators in accordance with aspects described herein. In some aspects, rather than generating a single percussion stem (e.g., the percussion stem 134), a source separation model can generate separate stems for different elements of the percussion. In the example of FIG. 5B, a source separation model generates a snare stem 135 and a kick stem 135 (e.g., two different percussion stems). Such stems can, in some aspects, relate to high and low frequency percussion stems. In such aspects, the drum transcription model 410 can process both stems, with illustrated drum transcription model 410A configured to process the snare stem 135, and drum transcription model 410B (e.g., which can be the same or different from the drum transcription model 410A in different implementations) configured to process the kick stem 136. Just as above, amplitude envelope calculators 522, 523 process the volume associated with the stems 135, 136. In the discrete indicators 540 and 550, the individual indicators are positioned horizontally at a time position associated with an onset of each element (e.g., hit or separate percussive waveform), and the length of each discrete indicator (e.g., in the vertical direction) represents the volume or energy associated with each element. In some aspects, the volume or magnitude determined by the amplitude envelope calculator 522, 523 is an energy accumulated between elements. In some aspects, the magnitude or volume is an energy calculated in a discrete or fixed time period following the onset of the element (e.g., a fixed time period following the position of the discrete element). In other aspects, other calculation methods can be used.

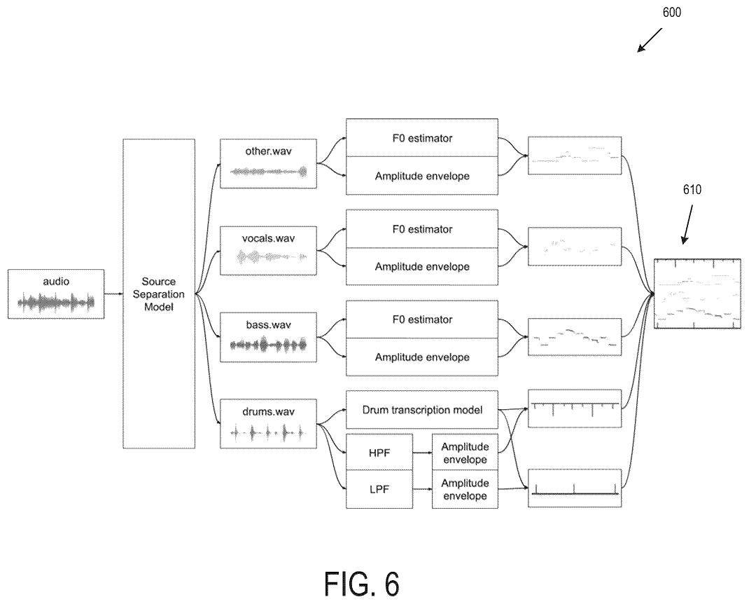

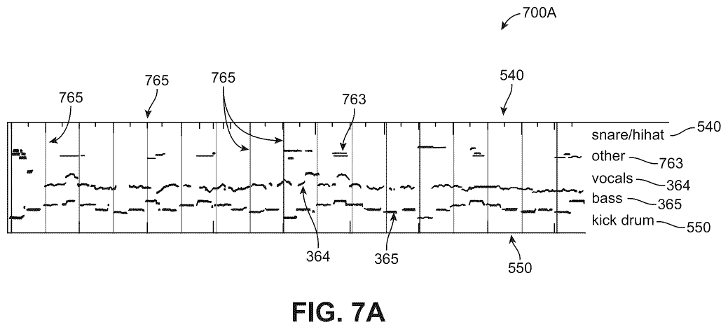

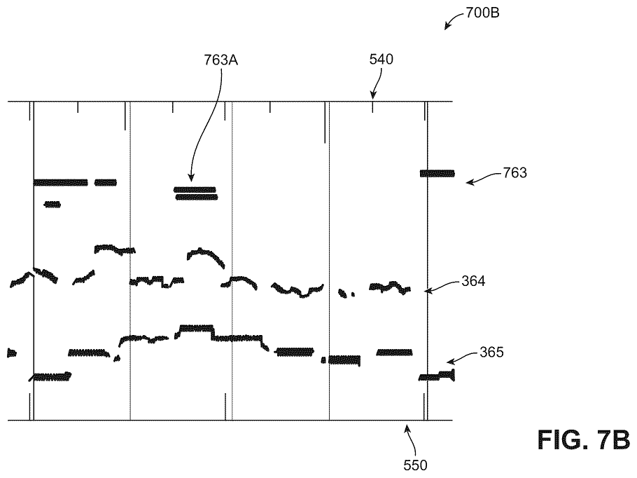

FIG. 6 illustrates aspects of a system 600 for stem generation, processing, and visualization in accordance with aspects described herein. The system 600 includes combined elements from FIGS. 1-5, with the audio data 110 input to the source separation model 120, which outputs stems 131, 132, 133, and 134. Each of the stems 131, 132, 133, and 134 can be processed to generate a compact stem representation, which can all be combined into a single compact visual stem representation 610 for the audio data 110. Additional details of the compact visual stem representation 610 is described in the context of FIGS. 7A and 7B below.

FIG. 7A and 7B illustrate aspects of compact music stem data visualization 700 in accordance with aspects described herein. FIG. 7A shows a representation 700A of multiple bars (e.g., groupings of beats for a timing value) of stem and discrete indicator visualizations for a portion of the audio data 110. FIG. 7B shows a representation 700B of a single bar of stem and discrete indicator visualizations for a portion of the audio data 110. The representation 700A includes the stem data 364 and 365, in addition to stem data 763, and discrete indicators 540 and 540 representing the percussion stems. The discrete indicators 540 represent high frequency percussion data, and the discrete indicators 550 represent low frequency percussion data. The stem data 364 is vocal stem data, the stem data 365 is bass data, and the stem data 763 represents the remaining instrumentation in the music data.

Additionally, these figures include timing indicators 765, which place the stem data 364, 365, and the discrete indicators 540, 550 within a context of a tempo of the song data. In some aspects, in addition to the audio 110 being input to the source separation model 120 as illustrated in FIGS. 1 and 6, the audio data can additionally be input to an analysis system or additional model for determining a tempo of the song. Such a system (e.g., a machine learning tempo analysis model) can identify a tempo for the music data, and generate timing indicators 765 to provide visual information about a tempo of the music as part of the compact music stem data visualization 700.

In the illustrated example of FIGS. 7A and 7B, the vertical dimension of the compact visual representation 700 is divided into roughly equal lanes for the 5 stems, with one stem assigned to each lane (e.g., and the percussion stem divided into two separate stems placed as discrete indicators in the top and bottom lanes). The discrete indicators for the divided percussion stems (e.g., the drum markers) extend a fixed maximum height based on an onset magnitude. In some aspects, linear scaling can be used for the discrete indicators to indicate a scaled volume from the maximum percussion value at the maximum high. For pitched stems (e.g., vocal stems, guitar stems, etc.) the mean and standard deviation of frequency can be computed over note samples for the song data. Note frequencies can be centered on the mean and scaled to a selected number of standard deviations. Scaling on distance from the mean can be linear or log-scaled in different implementations. In some aspects, outlier notes are allowed to overflow into neighboring lanes. In other aspects, outliner notes can be clipped, or placed at a lane edge with alternate coloring or note representation. In some aspects, volume representations can be generated by calculating an average volume over a short time window (e.g., for length of discrete elements representing percussion or for color or other volume representations in stem lines). In other aspects, a maximum amplitude can be used, but this results in higher variance than average volume representations.

As described above, in some implementations, a machine learning source separation model can generate stems that include data for individual instruments or instrument types. In some aspects, when certain instruments are removed, multiple instruments can remain and be grouped in a remaining stem for audio data not associated with a particular stem type. The stem 763 is illustrated as such a stem, and further includes time points 763A where multiple f0 frequencies are identified. In the illustration of FIGS. 7A and 7B, a double line or two points at the same time position are used for a stem to represent multiple f0 values or an ambiguous f0 value, which can represent multiple instruments planning different tones as part of the stem data 763.

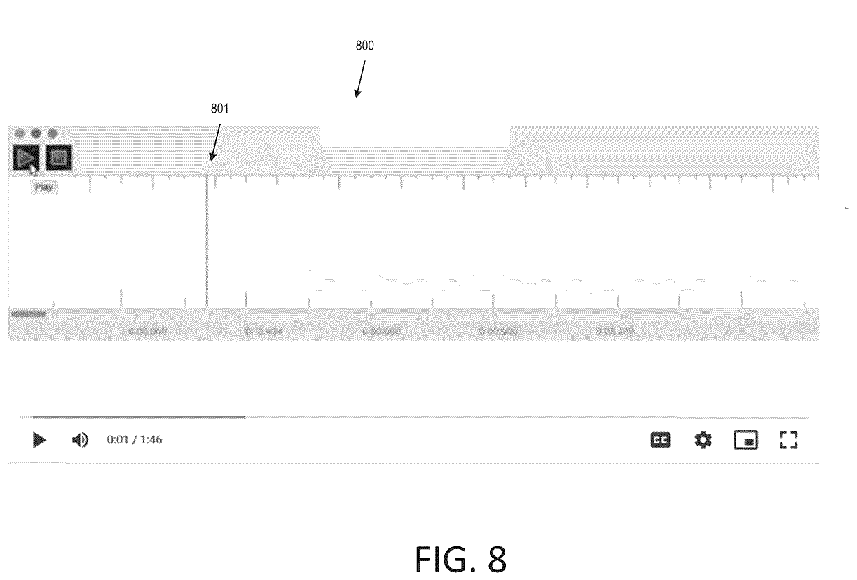

FIG. 8 illustrates aspects of a user interface (UI) 800 for compact music stem data visualization in accordance with aspects described herein. The UI 800 includes a play and a stop button, and an active time position indicator 801, indicating a current position for audio playback. During a play mode, audio signals output at a speaker are associated with the audio data from the indicated time within a time frame of the music data. During a stop or pause, the active time position indicator 801 indicates the position in the music data where the music will start. The stem data represented within the UI 800 corresponds to the compact representations detailed above within the simple audio playback of the UI 800. Such a simple UI allows a user to view the compact stem representation of the music, including upcoming portions of the music and portions of the music at the current time (e.g., the present audio output) as well as upcoming portions of the music data that will play if the audio playback of the music data is not paused.

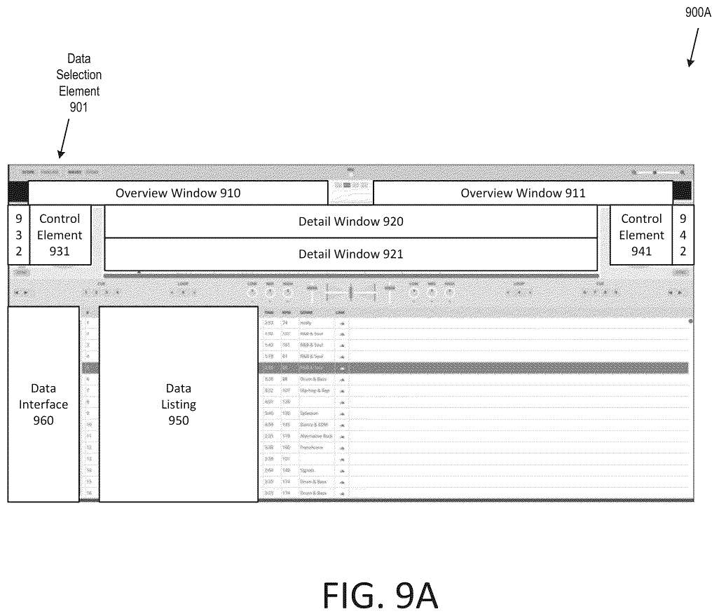

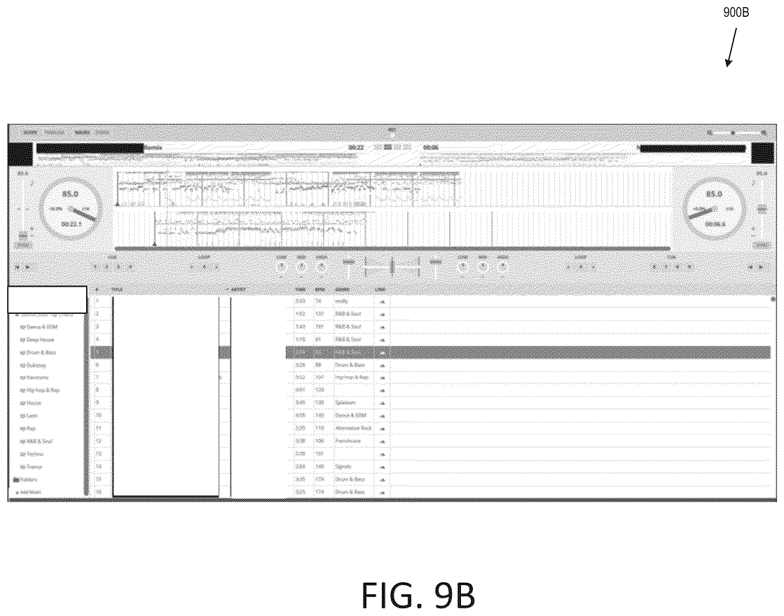

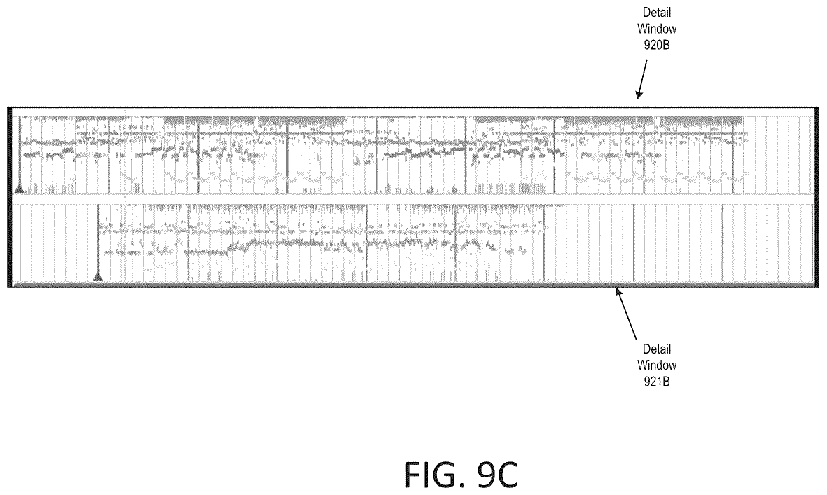

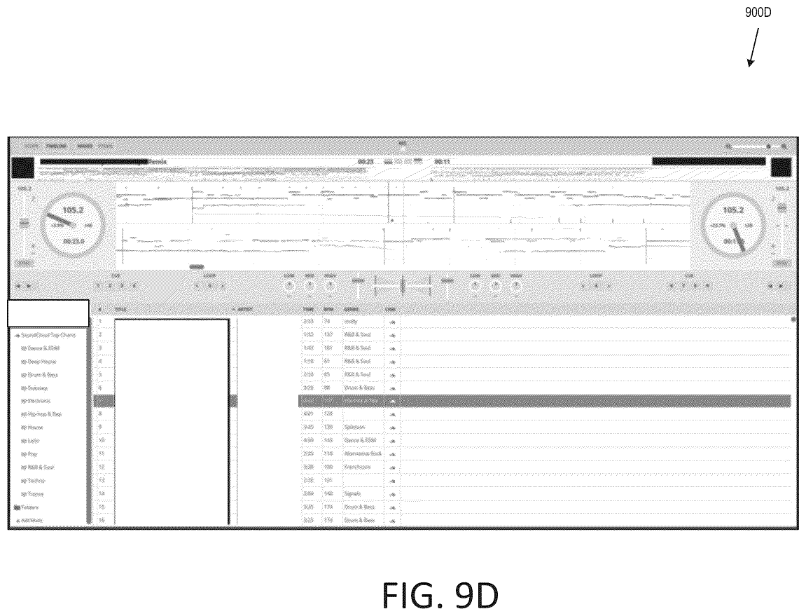

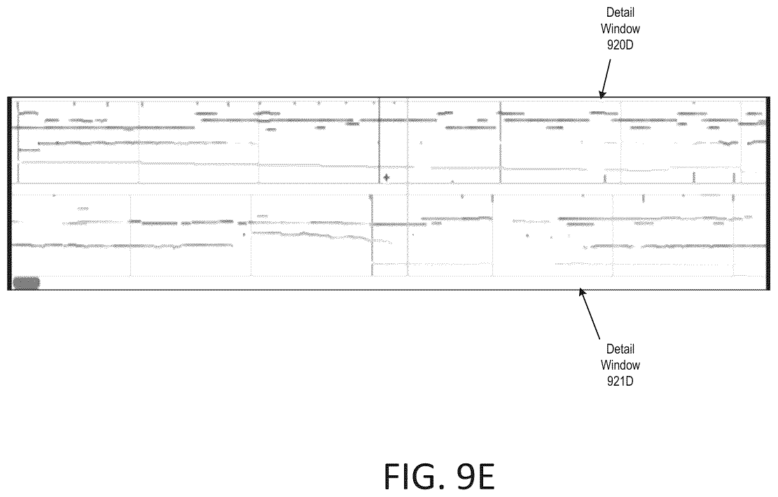

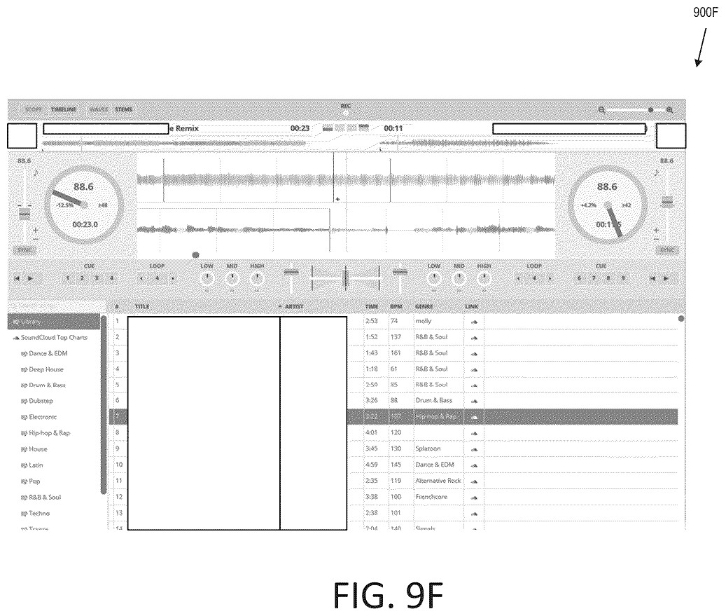

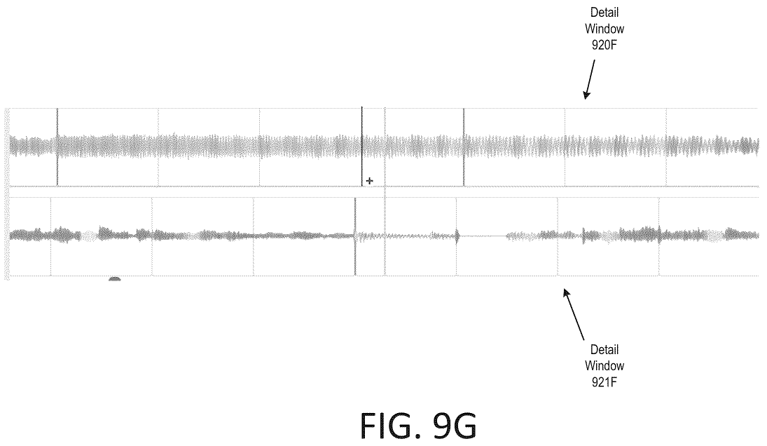

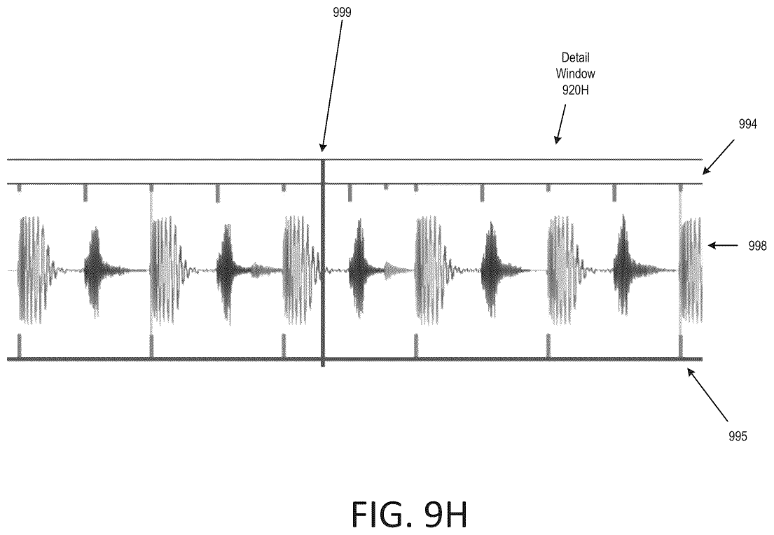

FIGS. 9A-9G represent a view 900A of a complex UI 900 for music mixing and processing which can be used as a DJ application in accordance with some aspects. The UI 900 includes data selection elements 901 that can be used to modify the data that is presented in detail windows 920 and 921. The detail windows 920 and 921 can be modified by the data selection elements to present visualizations of one or more song selections. Such visual elements can include an overview of compact stem visualization, as detailed FIGS. 9B and 9C, a close-up view of compact stem visualization as detailed in FIGS. 9D and 9E, or waveform visualizations as detailed in FIGS. 9F and 9G. Overview windows 910 and 911 can present a view of visualization data for an entire song scaled to fit within the overview window. Data selection elements 901 can select between a waveform overview visualization or a stem overview visualization. Control elements 931, 932, 941, and 942 can be used to synchronize or adjust timing between multiple songs, perform digital “scratch” effects, or perform other such mixing operations. Additional elements can be used to implement any number of mixing or processing operations on one or more sets of music data. Such operations can include fade-in, fade-out, filtering, or other operations.

Data interface 960 can be used to sort and select groupings of music or song data to be presented within data listing 950. The data listing 950 can include interface indicators for song selections. Selecting an interface indicator within data list 950 can involve dragging and dropping a song selection into a control element such as the control element 931 or the control element 941. In the illustrated UI 900, two songs can be selected at the same time, with visualization for a first song selection presented within overview window 910 and detail window 920, and visualization for a second song selection presented in overview window 911 and detail window 921.

In the illustrated UI 900, a large number of data selections and interface controls for mixing selected songs can be presented. As described above, traditional waveform visualizations do not provide sufficient information to allow on-the-fly mixing, and so pre-configured cues are used based on repeated listening and DJ analysis of music information to identify desired transition points for mixing, looping, or other effects. Such cue generation can be time consuming and repetitive. Aspects described herein provide visualization that can reduce such repetition and need for manual cue selection by providing compact stem visualization. Such compact stem visualization includes indicators associated with frequency (e.g., note), amplitude (e.g., volume) and instrumentation changes through the song, with a timeline that allows configurable previewing of upcoming features within a song. The use of multiple detail windows 920, 921 allows alignment of song features represented by stem information in multiple songs to facilitate real-time on-the-fly mixing with matched characteristics identifiable from information present in the stem visualization that is more difficult to discern or not available in the waveform visualization. The UI 900 with compact stem visualization in detail windows 920, 921 and overview windows 910, 911 thus improves operation of a device for music processing and mixing by reducing user time needed to prepare for and present mixing operations, and by allowing complex information to be presented in a single screen UI in a way not previously available.

FIG. 9B illustrates aspects of a view 900B of the user interface 900 for music processing and mixing with compact music stem data visualization in accordance with aspects described herein. FIG. 9B includes stem data visualization in overview windows 910, 911 and detail windows 920, 921 for two different music selections with different associated audio data and different associated stems visualized with compact stem visualizations. FIG. 9C illustrates view 920B of detail window 920 including a compact stem visualization of a first song selection, and view 921B of detail window 921 including a compact stem visualization of a second song selection. UI 900 selections can be used to adjust the synchronization and alignment of the time positions of the two song selections to allow mixing of different combinations of the song selections. In some aspects, UI 900 selections or controls can be used to select a portion of one song to be looped during playback, and for looped playback of one portion of one song selection mixed with looped or non-looped playback of data from the other song.

FIG. 9D illustrates a view 900D of UI 900, and FIG. 9E illustrates a view 920D of the detail window 920 and a view 921D of the detail window 921 shown in the view 900D of FIG. 9D. The close-up views 920D, 921D can make viewing details of the stem visualization easier, at the cost of losing the view of stem visualizations further output from a current play position which are visible in views 920B, 921B.

In each case, the compact stem visualization within the windows provides for stacked stems in overlapping lanes. Each stem of each song is stacked without an individual or joint frequency reference indicator, so that the relative frequency variations within a stem are apparent but presented in a compact manner without a scale reference. In some aspects, the stem for one song can be visualized to overflow into another lane for another stem depending on the dynamic range within the stem. Silent portions of a stem are presented as gaps in the stem lines. Volume representations can similarly be included in a lane as part of the lines for a stem (e.g., represented as color, brightness, line thickness, etc.) In some aspects, volume representations can fade to a gap with no minimum volume, in other aspects, volumes below a threshold value are represented as a gap with no associated line.

In some aspects, stems within a shared window (e.g., the detail window 920) are scaled within lanes of the detail window (e.g., with each lane of the detail window 920 having an assigned area) with a linear scaling. In other implementations, log scaling, clipped scaling within a threshold range, or other such scaling can be used. In some aspects, different lanes can have different scales for stems of the same song, depending on user preferences. In some aspects, the different stems can be assigned different colors by stem type to provide additional visual differentiation between stems, and to allow visual pairing of similar stem types from different song selections. In some aspects, stem hue can provide additional information, such as timbre variation, or other such information. Similarly, in some implementations, color intensity can be matched to stem volume in addition to the vertical axis representation.

As described above, in some aspects, an amplitude envelope can be generated with the intensity of each instrument computed using the log-amplitude envelope of the stem audio signal, normalized by the max amplitude of the signal. Log-amplitude is used because humans perceive loudness on a logarithmic scale. In some aspects, the point data at each time can be generated with a small line segment or group of points representing a musical note or musical notes (e.g., with two f0 frequencies present at the same time of a stem). In some aspects, not segmentation within a compact visual representation can be generated according to the following operations:
1. Samples are processed in chronological order
2. An active set of notes is maintained at each time consisting of samples
3. Each (time, frequency) sample is either:
   a. Filtered if it is below a threshold
   b. Appended to an existing note from the active set
   c. Added to active set as a new note
4. After each time step, a note is considered finalized if it was not extended with a new sample
   a. If the note is less than the minimum duration, it is dropped
   b. Otherwise, the note is persisted
      In other aspects, other such operations can be used to generate the point, line, or segment data to represent the amplitude of audio data within a stem.

In some aspects, a percussion (e.g., drum) stem can be processed using the operations above. In other aspects, percussion can be represented by multiple stems that are processed independently (e.g., as discussed above with respect to FIG. 5B). In other aspects a drum transcription model can be used alone or with filtering and envelope detection. In some aspects a drum detection model detects drum onset times from an audio file, and a second model classifies the drum into multiple subtypes. Such sub-types can include kick drum, snare drum, hi-hat, or other such drum types. In some aspects, the drum signal is split into low-frequency and high-frequency components using a low-pass (LPF) and high-pass (HPF) filter, and an amplitude envelope is computed for low-pass and high-pass components. For each component, a drum onset magnitude is calculated by integrating the amplitude over a short region before and after the onset time. Discrete indicators for drum sub-types can be split between upper and lower borders of an interface window. In some aspects, discrete indicators for drum onset magnitude can be normalized with a maximum value from the song data, with high and low signals normalized separately, and linear scaling.

FIGS. 9F and 9G illustrate a view 900F of UI 900 and views 920F, 921F consecutively associated with a waveform presentation that can be selected using data selection elements 901 to allow a user to select between waveform visual representations and compact stem visual representations of selected songs.

FIG. 9H illustrates additional aspects of a UI in accordance with aspects described herein. As detailed above, representations of percussive aspects of a music or a song can be represented as discrete indicators (e.g., lines indicating an onset of a percussive “hit” with a variable height to represent volume, energy, or intensity). In some aspects, a percussive stem representation (or multiple percussive stem representations) can be integrated with waveform data in accordance with some aspects. In some aspects, this can allow waveform data from pitched instruments (e.g., or combinations of pitched and unpitched instruments) to be combined with a compact percussion stem representation (e.g., as detailed above in FIGS. 4, 5A, 5B, etc.). FIG. 9H includes waveform representation 998 for a song, with compact percussion representation 994 and compact percussion representation 995 above and below the waveform 998 in a detail window 920H for percussive elements identified from the song by a source separation model. A user interface can switch between representation of the stem data (e.g., as shown in FIG. 9C, 9E, etc.) and the waveform representation 998, and a playback indicator 999 indicates a position in the data associated with audio playback.

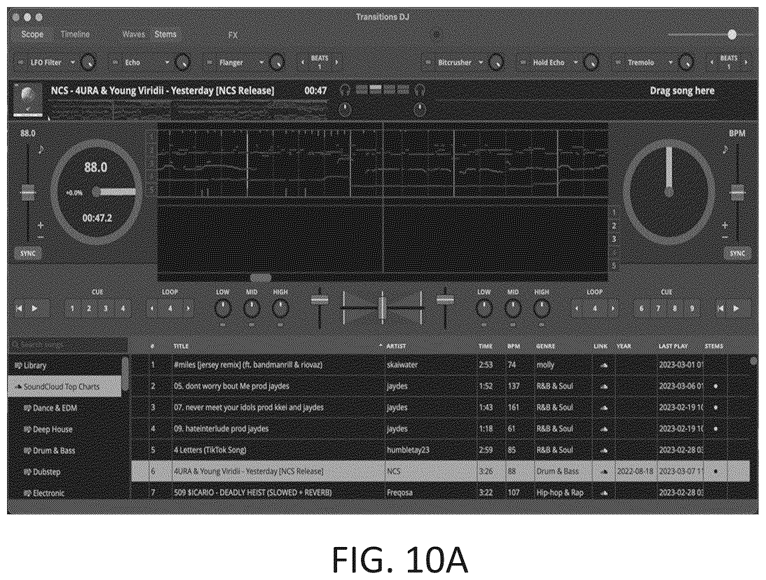

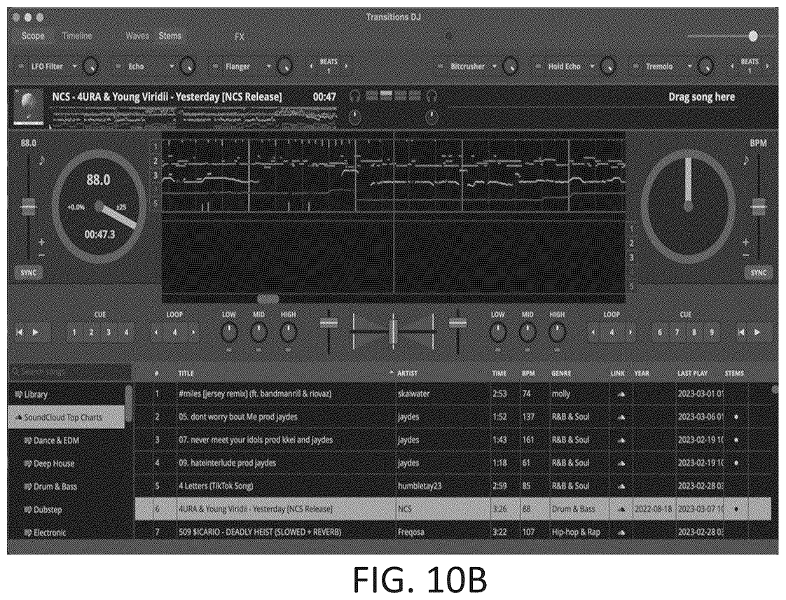

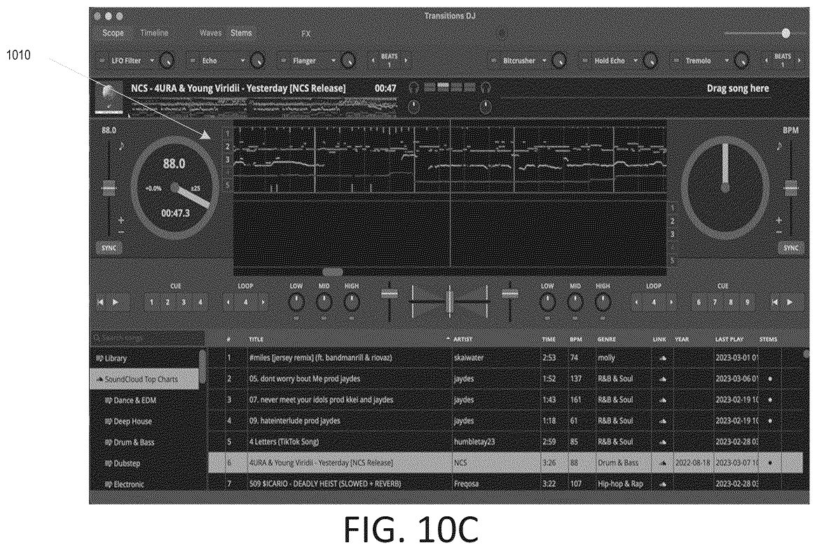

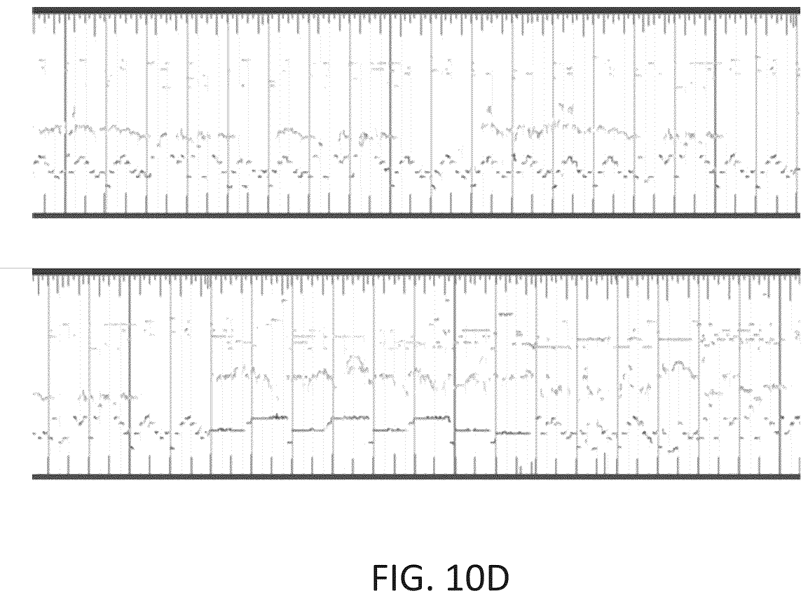

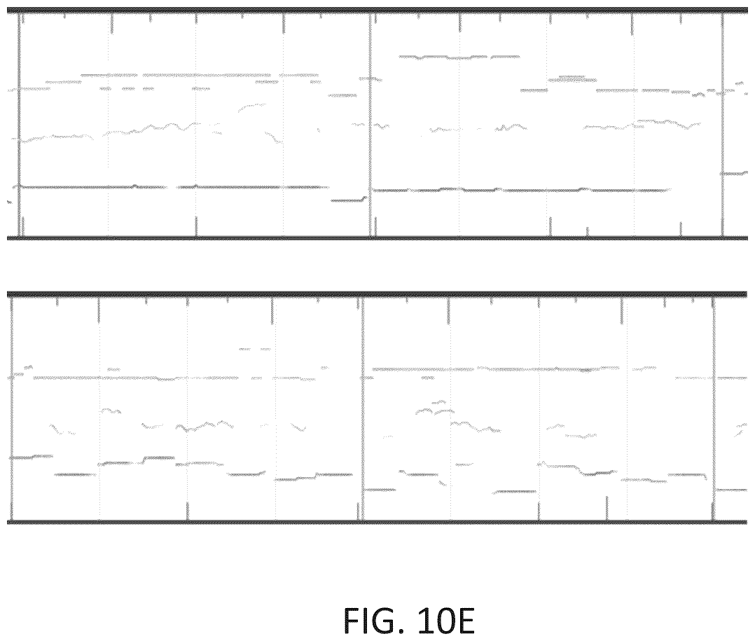

FIG. 10A-E provide additional examples of a user interface and associated compact stem visualization in accordance with aspects described herein. As described above, UI elements can allow for switching of representations of close or far (e.g., shorter or longer time frame representations) presentation, and between stem and waveform representations. FIGS. 10A-E illustrate additional examples of stem representations. FIG. 10C, in particular, illustrates UI elements 1010 which can allow for individual stems to be selected or deselected within a detail window (e.g., any detail window 920 presenting stem visualizations). Such UI elements allow certain stems to be displayed while other stems are not displayed within a detail window. For example, FIG. 1 illustrates a source separation model 120 that generates four stems 131, 132, 133, 134. UI elements 1010 can be used to select inclusion of the vocals stem 132 and the drums stem 134, and exclusion of the bass stem 133 and the other stem 131. In some aspects, such UI elements can impact only the compact visual representation presented in a detail window. Such an implementation allows a DJ to mix songs based on information for selected stems while filtering out information from the songs less relevant to the mixing. In other aspects, such a UI element can impact the audio generated by the system (e.g., so that only audio for selected waveforms are output) in addition to modifying the compact stem representation in one or more detail windows. Such aspects can allow stems from one song to be included while similar stems from a mixed song are excluded (e.g., inclusion of vocals and drums from one song, and exclusion of vocals and drums for another song being played at the same time).

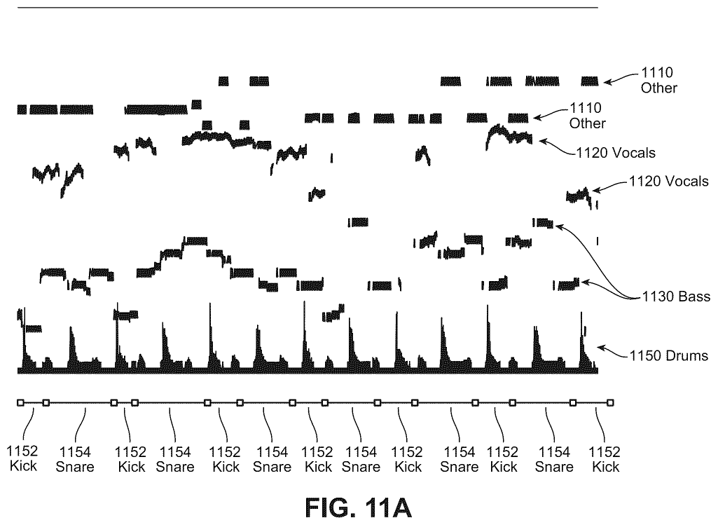

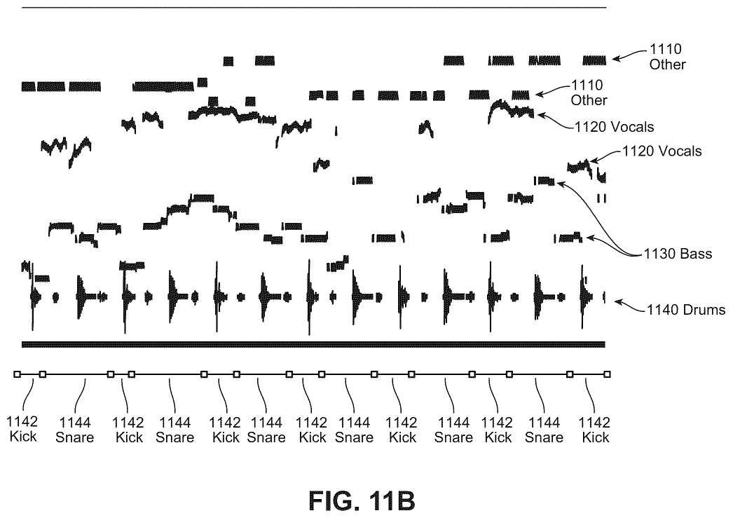

FIGS. 11A and 11B illustrate alternative implementations of a compact visual representation in accordance with some aspects. For example, in FIGS. 5A and 5B above, discrete indicators such as low frequency discrete indicators 540 and 550 are used. As indicated above, such separation of the high frequency percussion from the low frequency percussion can provide key rhythm information to a DJ performing real-time on-the-fly mixing, while maintaining a compact representation that allows complex stem data from instruments to occupy a user interface. In other aspects, additional detail of percussion may be preferred, such that a lane is assigned to percussion stems rather than using discrete indicators at interface edges to represent percussion.

FIG. 11A, for example, includes vocals stem 1120, bass stem 1130, drums stem 1150, and an other stem 1110. Each of the stems is assigned a lane to allow information from each stem (e.g., frequency and amplitude information) to be represented in separate lanes of a compact visual representation of a song. In FIG. 11a, the drum stem 1150 is represented by one-sided amplitude indicators extending from a border of the timing window. Unlike the other stems, since frequency data is not expected to be represented as changing in the drum stem 1150, the position can be fixed along the edge of the compact representation. For different discrete aspects of the drum stem 1150, other indicators can be used to represent the different elements. For example, in some aspects, the drum (e.g., percussion) stem is processed using a drum transcription model to generate a plurality of percussion indicators as described above. In the examples of FIGS. 11A and 11B, these include snare indicators 1154 and kick indicators 1152. In other aspects, alternative or additional indicators can be used (e.g., different indicators for tuned drums, different style drums, etc.). Rather than displaying the differences via a distinction in the vertical placement, color or space separation can be used to display the different percussion indicators on a shared line (e.g., as in FIG. 11A) or in a shared percussion lane (e.g., as in FIG. 11B) in a timing window of a compact song representation. In both FIGS. 11A and 11B, the stem data is represented within the separate lanes (e.g., stem lanes, stem lanes, etc.). The lanes can be represented with lane separation lines, or can be separated with lane positions, such that as the frequency information for a stem (e.g., a fundamental frequency represented by a vertical position within a lane) can be scaled to remain within a lane or to transgress into another lane. In some such aspects, processing of stem data can include identifying the breadth of frequency variation, and can scale each representation by stem for a lane. The frequency scaling for each stem can be generated separately to keep the representation of each stem within an associated lane. In other aspects, a common scaling (e.g., pixels or distance per frequency value/octave/etc.). In various aspects, dynamically displaying the first song amplitude indicators in the timing window includes displaying each stem within a separate stem lane of the timing window with the amplitude of each stem represented by a stem waveform and a frequency indicator of each stem represented by a vertical position of the waveform within each corresponding stem lane.

FIG. 11B includes the same vocals stem 1120, bass stem 1130, other stem 1110, but with a different drum step illustrated as drum stem 1140. In FIG. 11B, the drum stem is segmented as a plurality of percussion indicators configured as two-sided amplitude indicators floating within a shared percussion lane of the timing window. In FIG. 11B, a shared floating line in the percussion lane is used, with different position or color indicators in the percussion lane to distinguish between the kick indicators 1142 and the snare indicators 1144. In other aspects, high frequency percussion and low frequency percussion can be configured in the same was as illustrated in either FIG. 11A or 11B, in separate lanes or border lines. For example, in some aspects, a high pass percussion line can be positioned on the top edge of the border with the low pass percussion line on the bottom border as illustrated in FIG. 11A. In another example, separate lanes can be provided for high and low pass percussion similar to the single percussion lane of FIG. 11B, with the high pass lane including separate indicators for hi-hat, cymbal, snare drum, and/or other high frequency percussive audio, while a low frequency percussive lane can include the kick 1142, and/or other low frequency percussive elements. Such aspects (e.g., percussion lines and/or lanes) can be combined in any fashion with any other aspect described herein (e.g., use of a one-sided percussion border line for some percussive elements, and a two-sided percussion lane for other elements, with shared space separated or color coded indicators within each lane or line to distinguish between the elements.

Similarly, in some aspects, segmentation can be used for non-percussive elements in a shared lane. For example, vocals from different singers can be represented in a shared vocal lane with different color representations for voice data for each singer, different instrument representations can be placed in a shared lane (e.g., trumpet and trombone or different guitars, etc.), within the scope of the aspects described herein

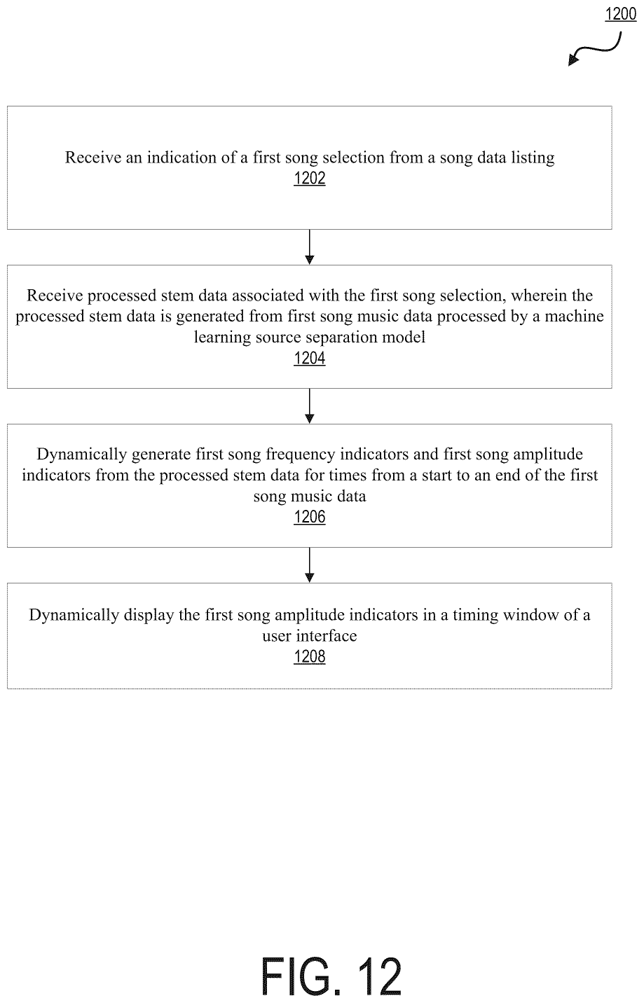

FIG. 12 illustrates a method 1200 for implementing a compact music stem data visualization in accordance with aspects described herein. In some aspects, method 1200 is implemented by one or more processors of a computing device. In some aspects, the method 1200 is implemented by a cloud based server computing system to facilitate presentation of stem visualizations of a user device. In some aspects, the method 1200 is implemented as instructions stored in a non-transitory computer readable storage medium that, when executed by one or more processors of a device, cause the device to perform operations of blocks 1202, 1204, 1206, and 1208 of the method 1200.

The method 1200 includes block 1202, which includes receiving an indication of a first song selection from a song data listing.

The method 1200 includes block 1204, which includes receiving processed stem data associated with the first song selection, wherein the processed stem data is generated from first song music data processed by a machine learning source separation model.

The method 1200 includes block 1206, which includes dynamically generating first song frequency indicators and first song amplitude indicators from the processed stem data for times from a start to an end of the first song music data.

The method 1200 includes block 1208, which includes dynamically displaying the first song amplitude indicators in a timing window of a user interface.

In some aspect, the method 1200 or any other method described herein can include repeated or intervening operations. In some aspects, a server implementing the operations of the method 1200 can perform many simultaneous instances of the method 1200 at the same time, such that hundreds or thousands of instances of operations of such a method can be performed at the same time by a computing system.

Some such aspects can include additional operations. For example, in some aspects, the techniques described herein relate to a computer-implemented method, further including: receiving indication of a second song selection from a song data listing; receiving second processed stem data associated with the second song selection, wherein the second processed stem data is generated from second song music data processed by the machine learning source separation model; dynamically generating second song frequency indicators and second song amplitude indicators adjacent to the first song amplitude indicators in the timing window of the user interface.

In some aspects, the techniques described herein relate to a computer-implemented method, wherein the processed stem data includes stem data for a fixed set of stems including a vocal stem, one or more instrumental stems, and a percussion stem.

In some aspects, the techniques described herein relate to a computer-implemented method, further including: dynamically generating second song amplitude indicators adjacent to the first song amplitude indicators in the timing window of the user interface; receiving a synchronize input associated with the first song selection; and adjusting a tempo associated with the first song selection to match a tempo associated with the second song selection; and shifting relative positions of the first song amplitude indicators in the timing window of the user interface based on adjustment of the tempo associated with the first song.

In some aspects, the techniques described herein relate to a computer-implemented method, further including dynamically displaying the first song amplitude indicators in the timing window of a user interface as an overview of an entirety of the first song selection; and dynamically displaying an enlarged portion of the first song amplitude indicators around a selected time position for the first song selection.

In some aspects, the techniques described herein relate to a computer-implemented method, further including: receiving a selection of a first time portion of the first song selection; automatically generating a loop of the first time portion of the first song selection; and dynamically displaying looped portion amplitude indicators in the timing window matching the loop of the first time portion of the first song selection.

In some aspects, the techniques described herein relate to a computer-implemented method, wherein the first song frequency indicators include a vertical placement within a stem lane representing frequencies of music at a time within the timing window.

In some aspects, the techniques described herein relate to a computer-implemented method, wherein the first song amplitude indicators include one or more of a line color intensity, a line color, or a line thickness at the time within the timing window.

In some aspects, the techniques described herein relate to a computer-implemented method, wherein the first song frequency indicators include a plurality of lines at different vertical placements within a stem lane, wherein each line of the plurality of lines represents a different frequency of a chord at the time within the timing window.

In some aspects, the techniques described herein relate to a computer-implemented method, further including: dynamically identifying a percussion stem from the processed stem data; processing the percussion stem using a drum transcription model to generate discrete percussion indicators; and dynamically displaying the discrete percussion indicators with the first song amplitude indicators in the timing window of the user interface.

In some aspects, the techniques described herein relate to a computer-implemented method, further including: dynamically identifying a percussion stem from the processed stem data; processing the percussion stem using a drum transcription model to generate a plurality of percussion indicators.

In some aspects, the techniques described herein relate to a computer-implemented method, wherein the plurality of percussion indicators include snare indicators and kick indicators.

In some aspects, the techniques described herein relate to a computer-implemented method, wherein the plurality of percussion indicators are each individually identified by a separate color within a shared percussion lane in the timing window.

In some aspects, the techniques described herein relate to a computer-implemented method, wherein the plurality of percussion indicators include one-sided amplitude indicators extending from a border of the timing window.

In some aspects, the techniques described herein relate to a computer-implemented method, wherein the plurality of percussion indicators include two-sided amplitude indicators floating within a shared percussion lane of the timing window.

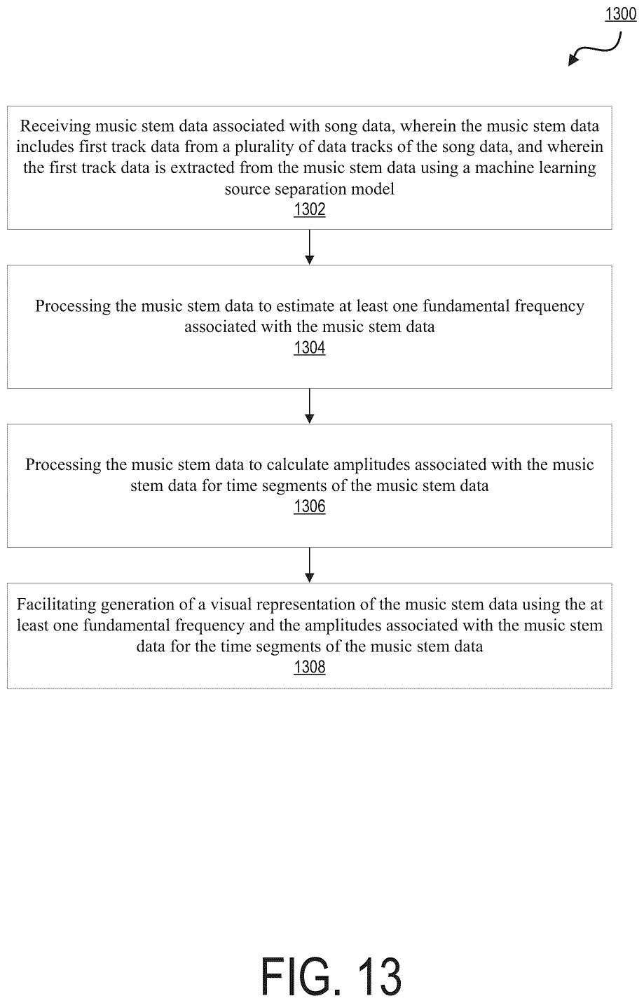

FIG. 13 is a flowchart of an example method 1300 for implementing a compact music stem data visualization in accordance with aspects described herein. In some aspects, method 1300 is implemented by one or more processors of a computing device. In some aspects, the method 1300 is implemented by a cloud based server computing system to facilitate presentation of stem visualizations of a user device. In some aspects, the method 1300 is implemented as instructions stored in a non-transitory computer readable storage medium that, when executed by one or more processors of a device, cause the device to perform operations 1302, 1304, 1306, and 1308 of the method 1300.

The method 1300 includes block 1302 which describes receiving music stem data associated with song data, wherein the music stem data includes first track data from a plurality of data tracks of the song data, and wherein the first track data is extracted from the music stem data using a machine learning source separation model.

The method 1300 includes block 1304 which describes processing the music stem data to estimate at least one fundamental frequency associated with the music stem data.

The method 1300 includes block 1306 which describes processing the music stem data to calculate amplitudes associated with the music stem data for time segments of the music stem data.

The method 1300 includes block 1308 which describes facilitating generation of a visual representation of the music stem data using the at least one fundamental frequency and the amplitudes associated with the music stem data for the time segments of the music stem data.

In some such aspects, the techniques described herein relate to a computer-implemented method, further including: receiving second music stem data associated with the song data, wherein the second music stem data includes second track data different from the first track data, and wherein the second track data is extracted from the music stem data using the machine learning source separation model; processing the second music stem data to estimate at least one fundamental frequency associated with the second music stem data; processing the second music stem data to calculate amplitudes associated with the second music stem data for the time segments of the music stem data; and facilitating generation of the visual representation of using the amplitudes associated with the second music stem data with the amplitudes associated with the music stem data to generate a compact visual representation of the plurality of data tracks of the song data in detailed windows of a user interface.

In some such aspects, the techniques described herein relate to a computer-implemented method, wherein the detailed windows have aligned timing indicators.

In some such aspects, the techniques described herein relate to a computer-implemented method, wherein the aligned timing indicators are generated automatically by a machine learning tempo identification model from the song data to represent a time signature associated with the music stem data. In some aspects, the alignment timing indicators can be generated from the stem data.

In some such aspects, the techniques described herein relate to a computer-implemented method, wherein the music stem data is associated with a first musical instrument, and wherein the second music stem data is associated with one or more percussion instruments.

In some such aspects, the techniques described herein relate to a computer-implemented method, wherein the music stem data is associated with a first musical instrument, and wherein the second music stem data is associated with a plurality of instruments.

In some such aspects, the techniques described herein relate to a computer-implemented method, wherein processing the music stem data to estimate at the least one fundamental frequency identifies a first fundamental frequency associated with a first set of the plurality of instruments and a second fundamental frequency associated with a second set of the plurality of instruments.

In some such aspects, the techniques described herein relate to a computer-implemented method, wherein the compact visual representation includes a double line representing the first fundamental frequency, the second fundamental frequency, and the amplitudes for the second music stem data.

In some such aspects, the techniques described herein relate to a computer-implemented method, further including: receiving third music stem data associated with the song data, wherein the third music stem data includes third track data different from the first track data and the second track data, and wherein the third track data is extracted from the music stem data using the machine learning source separation model; dynamically identifying the third music stem data as associated with percussion instruments; processing the third music stem data using a drum transcription model; generating a set of discrete percussion indicators aligned with a timing of the music stem data.

In some such aspects, the techniques described herein relate to a computer-implemented method, wherein the compact visual representation includes the set of discrete percussion indicators at a top or a bottom of a detail window including representations for the music stem data and the second music stem data.

In some such aspects, the techniques described herein relate to a computer-implemented method, further including: processing the third music stem data using a high pass filter to generate high frequency percussion data; processing the high frequency percussion data to calculate amplitudes associated with the high frequency percussion data for time segments of the music stem data.

In some such aspects, the techniques described herein relate to a computer-implemented method, wherein the compact visual representation includes discrete percussion indicators for the high frequency percussion data at a top of a detail window.

In some such aspects, the techniques described herein relate to a computer-implemented method, further including: processing the third music stem data using a low pass filter to generate low frequency percussion data; processing the low frequency percussion data to calculate amplitudes associated with the low frequency percussion data for time segments of the music stem data.

In some such aspects, the techniques described herein relate to a computer-implemented method, wherein the compact visual representation includes discrete percussion indicators for the low frequency percussion data at a bottom of a detail window.

In some such aspects, the techniques described herein relate to a computer-implemented method, wherein the method is performed by a cloud server system to facilitate display of the compact visual representation on a user device.

In some such aspects, the techniques described herein relate to a computer-implemented method, wherein the method is performed by a mobile computing device after receiving the song data from a network server.

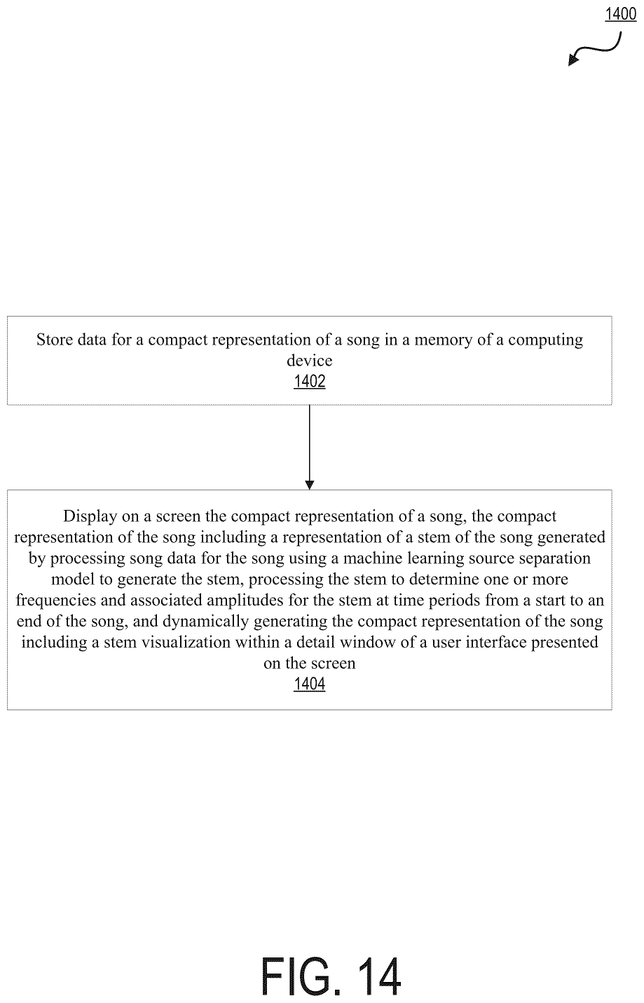

FIG. 14 is a flowchart of an example method 1400 for implementing a compact music stem data visualization in accordance with aspects described herein. In some aspects, method 1400 is implemented by one or more processors of a computing device. In some aspects, the method 1400 is implemented by a cloud based server computing system to facilitate presentation of stem visualizations of a user device. In some aspects, the method 1400 is implemented as instructions stored in a non-transitory computer readable storage medium that, when executed by one or more processors of a device, cause the device to perform operations 1402 and 1404.

The method 1400 includes block 1402, which describes storing data for a compact representation of a song in a memory of a device. Such a compact representation can be generated in accordance with details described above, or using any other operations.

The method 1400 further includes block 1404, which describes displaying the compact representation of the song on a display, the compact representation of the song including a representation of a stem of the song generated by processing song data for the song using a machine learning source separation model to generate the stem, processing the stem to determine one or more frequencies and associated amplitudes for the stem at time periods from a start to an end of the song, and dynamically generating the compact representation of the song including a stem visualization within a detail window of a user interface presented on the screen.

In some such aspects, the techniques described herein relate to a computing device, wherein the compact representation of the song further includes representations for a plurality of stems of the song generated by processing the song data using the machine learning source separation model and processing the plurality of the stems to generate the compact representation including relative amplitude lines for each stem of the plurality of stems in the detail window.

In some such aspects, the techniques described herein relate to a computing device, wherein the compact representation of the song further includes a representation of a percussion stem of the song generated by processing the song data using the machine learning source separation model and processing the percussion stem to generate discrete indicators associated with the percussion stem at the time periods from the start to the end of the song.

In some such aspects, the techniques described herein relate to a computing device, wherein the computing device is further configured to display on the screen a compact representation of a second song within the detail window adjacent to the compact representation of the song, wherein the compact representation of the second song is generated by the machine learning source separation model and processed to match a timing of the second song to a timing of the song.

In some such aspects, the techniques described herein relate to a computing device including a display screen, the computing device being configured to display on the screen a compact representation of a song, the compact representation of the song including a representation of a percussion stem of the song generated by processing song data for the song using a machine learning source separation model to generate the percussion stem, processing the percussion stem using one or more of a drum transcription model, a filter, and an amplitude envelope detector to generate discrete indicators associated with the percussion stem, and dynamically generating the compact representation of the song including the discrete indicators within a detail window of a user interface presented on the screen.

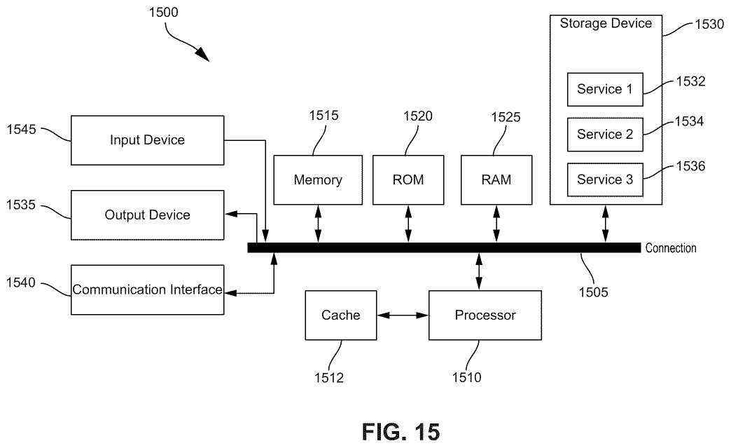

FIG. 15 is a diagram illustrating an example of a system for implementing certain aspects of the present technology. In particular, FIG. 15 illustrates an example of computing system 1500 which can include systems or elements of a system for music stem visualization and management in accordance with aspects described herein. Software, an application, or elements of a system for stem visualization can be integrated with any local computing device, a remote or cloud-based computing system, a camera, a tablet, a mobile device, or any combination of components in communication with each other using connection 1505 to communicate as part of implementing stem visualization in accordance with aspects described herein. Connection 1505 may be a physical connection using a bus, or a direct connection into processor 1510, such as in a chipset architecture. Connection 1505 may also be a virtual connection, networked connection, or logical connection.

Example system 1500 includes at least one processing unit (CPU or processor) 1510 and connection 1505 that communicatively couples various system components including system memory 1515, such as read-only memory (ROM) 1520 and random access memory (RAM) 1525 to processor 1510. Computing system 1500 may include a cache 1512 of high-speed memory connected directly with, in close proximity to, or integrated as part of processor 1510.

Processor 1510 may include any general purpose processor and a hardware service or software service, such as services 1532, 1534, and 1536 stored in storage device 1530, configured to control processor 1510 as well as a special-purpose processor where software instructions are incorporated into the actual processor design. Processor 1510 may essentially be a completely self-contained computing system, containing multiple cores or processors, a bus, memory controller, cache, etc. A multi-core processor may be symmetric or asymmetric. In some aspects, a service such as the service 1532 can include an artificial intelligence (AI) accelerator, including hardware for performing operations specifically associated with a machine learning engine used to generate music stems from data, or to generate audio files or visualization data from information in accordance with aspects described herein

To enable user interaction, computing system 1500 includes an input device 1545, which may represent any number of input mechanisms, such as a microphone for speech or audio detection along with other input devices 1545 such as a touch-sensitive screen for gesture or graphical input, keyboard, mouse, motion input, speech, etc. Computing system 1500 may also include output device 1535, which may be one or more of a number of output mechanisms. In some instances, multimodal systems may enable a user to provide multiple types of input/output to communicate with computing system 1500.

Computing system 1500 may include communications interface 1540, which may generally govern and manage the user input and system output. The communication interface may perform or facilitate receipt and/or transmission wired or wireless communications using wired and/or wireless transducers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Storage device 1530 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L#) cache), resistive random-access memory (RRAM/ReRAM), phase change memory (PCM), spin transfer torque RAM (STT-RAM), another memory chip or cartridge, and/or a combination thereof.

The storage device 1530 may include software services, servers, services, etc., that when the code that defines such software is executed by the processor 1510, it causes the system to perform a function. In some embodiments, a hardware service that performs a particular function may include the software component stored in a computer-readable medium in connection with the necessary hardware components, such as processor 1510, connection 1505, output device 1535, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

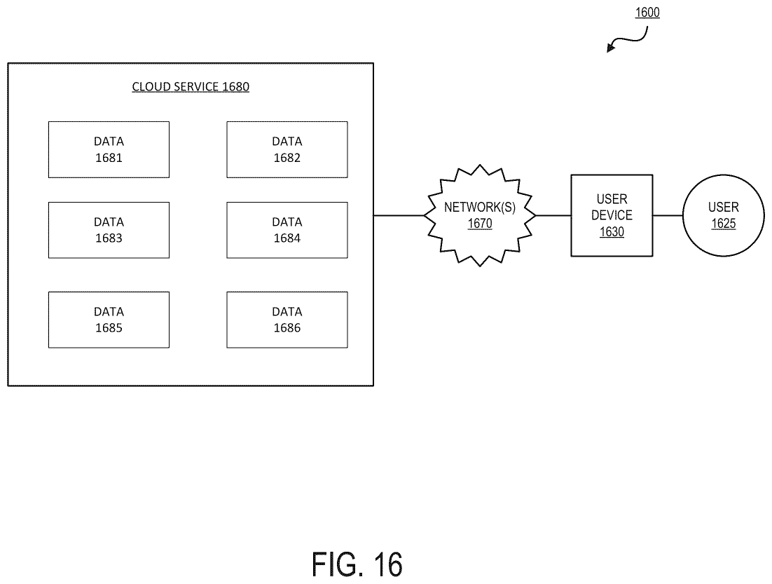

FIG. 16 shows a block diagram of an embodiment of a communication system 1600 which implements and supports certain embodiments and features described herein. In particular, certain embodiments relate to establishing connections between a user device 1630 (which can be operated by a user 1625), and a system for a cloud service 1680 (which can facilitate cloud services to support music visualization at the user device 1630 in accordance with aspects described herein. The user device 1630 can be a device such as the computing system 1500 or any other device described herein including a display configurable to present compact visualizations of music stem data for songs as described herein. As part of such facilitation, the user device 1630 can include speakers for playing music data synchronized to a play position indicated within the compact visualization(s) of the song.

In some embodiments, a user 1625 can be a device user processing music either for later playback or for a live performance at a show using compact visualizations of the music stem data in real-time to mix and modify song data for output on speakers of the user device 1630.

While FIG. 16 shows only a single user device 1630, a communication system 1600 can include multiple or many (e.g., tens, hundreds or thousands) of each of one or more of these types of devices connected to a cloud service 1680.

The networks 1670 can facilitate routing of communications, signals, commands, or any data (e.g., stem data, music data, song data, etc.) between the cloud service 1680 and the user device 1630. While the cloud service 1680 is illustrated as a single system storing data 1681, 1682, 1683, 1684, 1685, 1686, in various aspects, the cloud service can include multiple networked systems. For example, the cloud service 1680 can include both a repository of music data (e.g., digital song data, with data 1681-1386 representing songs playable on a device that can be processed by a machine learning source separation model) as well as cloud based processing resources manageable by the user device 1630 to initiate processing of song data to generate music stem data for one or more songs. In other aspects, the cloud service 1680 can be a repository of previously generated music stem data, with each of the illustrated data 1681-1386 representing stem data previously generated from music or song data.

A communication between the cloud service 1680 and the user device 1630 can include requests to access and/or generate music stem data from a selection of a song received at the user device 1630. The communication can also include additional data, such as data about a transmitting device (e.g., an IP address, account identifier, device type and/or operating system); a destination address; an identifier of a user; an identifier of a webpage or webpage element (e.g., a webpage or webpage element being visited when the communication was generated or otherwise associated with the communication) or online history data; a time (e.g., time of day and/or date); and/or destination address. In other aspects, any other information can be included, such as security data, license data, or other such data, in the communication.

Similarly, while one network 1670 is illustrated, communications can occur over one or more networks 1670. Any combination of open or closed networks can be included in the one or more networks 1670. Examples of suitable networks include the Internet, a personal area network, a local area network (LAN), a wide area network (WAN), or a wireless local area network (WLAN). Other networks may be suitable as well. The one or more networks 1670 can be incorporated entirely within or can include an intranet, an extranet, or a combination thereof. In some embodiments, a network in the one or more networks 1670 includes a short-range communication channel, such as a Bluetooth or a Bluetooth Low Energy channel. In one embodiment, communications between two or more systems and/or devices can be achieved by a secure communications protocol, such as secure sockets layer (SSL) or transport layer security (TLS). In addition, data and/or transactional details may be encrypted based on any convenient, known, or to be developed manner, such as, but not limited to, Data Encryption Standard (DES), Triple DES, Rivest-Shamir-Adleman encryption (RSA), Blowfish encryption, Advanced Encryption Standard (AES), CAST-128, CAST-256, Decorrelated Fast Cipher (DFC), Tiny Encryption Algorithm (TEA), extended TEA (XTEA), Corrected Block TEA (XXTEA), and/or RC5, etc.

A user device 1630 can include, for example, a portable electronic device (e.g., a smart phone, tablet, laptop computer, or smart wearable device) or a non-portable electronic device (e.g., one or more desktop computers, smart appliances, servers, and/or processors). The user device 1630 can execute a software agent or application to facilitate aspects described herein, including generation of stem data and/or processing of stem data to generate display elements for presentation in a compact representation on a display of the user device 1630. In one instance, the software agent or application is configured such that various depicted elements can act in complementary manners. For example, a software agent on a device can be configured to collect and transmit data about device usage to a separate connection management system, and a software application on the separate connection management system can be configured to receive and process the data.

In some aspects, the cloud service 1680 can implement functions (e.g., code-snippets or templates) on behalf of the customer represented by user 1625 and user device 1630 to process song or music data. The functions can implement machine learning source separation models, drum transcription models, filters, amplitude envelope detectors, fundamental (f0) frequency detectors, or any other such models using input song or music data to generate stem data as described herein. The functions can be executed within a defined function of the cloud service 1680 without the need for user 1625 to set up a user server to host the functions, and to allow the user device 1630 to access data or processing services to facilitate music visualization as described herein.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The instructions, media for conveying such instructions, computing resources for executing them, and other structures for supporting such computing resources are example means for providing the functions described in the disclosure.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

It is also noted that individual implementations may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

The various examples discussed above may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments). A processor(s), implemented in an integrated circuit, may perform the necessary tasks.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The techniques described herein may also be implemented in electronic hardware, computer software, firmware, or any combination thereof. Such techniques may be implemented in any of a variety of devices such as general purpose computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

Aspects of the above disclosure include, but are not limited to the following:
Aspect 1. A computer-implemented method comprising: receiving music stem data associated with song data, wherein the music stem data includes first track data from a plurality of data tracks of the song data, and wherein the first track data is extracted from the music stem data using a machine learning source separation model; processing the music stem data to estimate at least one fundamental frequency associated with the music stem data; processing the music stem data to calculate amplitudes associated with the music stem data for time segments of the music stem data; and facilitating generation of a visual representation of the music stem data using the at least one fundamental frequency and the amplitudes associated with the music stem data for the time segments of the music stem data.
Aspect 2. The computer-implemented method of Aspect 1, further comprising: receiving second music stem data associated with the song data, wherein the second music stem data includes second track data different from the first track data, and wherein the second track data is extracted from the music stem data using the machine learning source separation model; processing the second music stem data to estimate at least one fundamental frequency associated with the second music stem data; processing the second music stem data to calculate amplitudes associated with the second music stem data for the time segments of the music stem data; and facilitating generation of the visual representation of using the amplitudes associated with the second music stem data with the amplitudes associated with the music stem data to generate a compact visual representation of the plurality of data tracks of the song data in detailed windows of a user interface.
Aspect 3. The computer-implemented method of Aspect 2, wherein the detailed windows have aligned timing indicators.
Aspect 4. The computer-implemented method of Aspect 3, wherein the aligned timing indicators are generated automatically by a machine learning tempo identification model from the song data to represent a time signature associated with the music stem data. In some aspects, the alignment timing indicators can be generated from the stem data.
Aspect 5. The computer-implemented method of Aspect 2, wherein the music stem data is associated with a first musical instrument, and wherein the second music stem data is associated with one or more percussion instruments.
Aspect 6. The computer-implemented method of Aspect 2, wherein the music stem data is associated with a first musical instrument, and wherein the second music stem data is associated with a plurality of instruments.
Aspect 7. The computer-implemented method of Aspect 6, wherein processing the music stem data to estimate at the least one fundamental frequency identifies a first fundamental frequency associated with a first set of the plurality of instruments and a second fundamental frequency associated with a second set of the plurality of instruments.
Aspect 8. A system comprising: a memory configured to store music stem data associated with song data; and one or more processors coupled to the memory and configured to perform operations including: receiving the music stem data associated with the song data, wherein the music stem data includes first track data from a plurality of data tracks of the song data, and wherein the first track data is extracted from the music stem data using a machine learning source separation model; processing the music stem data to estimate at least one fundamental frequency associated with the music stem data; processing the music stem data to calculate amplitudes associated with the music stem data for time segments of the music stem data; and facilitating generation of a visual representation of the music stem data using the at least one fundamental frequency and the amplitudes associated with the music stem data for the time segments of the music stem data.
Aspect 9. The system of Aspect 8, wherein the one or more processors are configured for operations further comprising: receiving second music stem data associated with the song data, wherein the second music stem data includes second track data different from the first track data, and wherein the second track data is extracted from the music stem data using the machine learning source separation model; processing the second music stem data to estimate at least one fundamental frequency associated with the second music stem data; processing the second music stem data to calculate amplitudes associated with the second music stem data for the time segments of the music stem data; and facilitating generation of the visual representation of using the amplitudes associated with the second music stem data with the amplitudes associated with the music stem data to generate a compact visual representation of the plurality of data tracks of the song data in detailed windows of a user interface.
Aspect 10. The system of Aspect 9, wherein the detailed windows have aligned timing indicators.
Aspect 11. The system of Aspect 10, wherein the aligned timing indicators are generated automatically by a machine learning tempo identification model from the song data to represent a time signature associated with the music stem data. In some aspects, the alignment timing indicators can be generated from the stem data.
Aspect 12. The system of Aspect 9, wherein the music stem data is associated with a first musical instrument, and wherein the second music stem data is associated with one or more percussion instruments.
Aspect 13. The system of Aspect 9, wherein the music stem data is associated with a first musical instrument, and wherein the second music stem data is associated with a plurality of instruments.
Aspect 14. The system of Aspect 13, wherein processing the music stem data to estimate at the least one fundamental frequency identifies a first fundamental frequency associated with a first set of the plurality of instruments and a second fundamental frequency associated with a second set of the plurality of instruments.
Aspect 15. A non-transitory computer readable storage medium comprising instructions that, when executed by one or more processors of a device, cause the device to perform operations including: receiving music stem data associated with song data, wherein the music stem data includes first track data from a plurality of data tracks of the song data, and wherein the first track data is extracted from the music stem data using a machine learning source separation model; processing the music stem data to estimate at least one fundamental frequency associated with the music stem data; processing the music stem data to calculate amplitudes associated with the music stem data for time segments of the music stem data; and facilitating generation of a visual representation of the music stem data using the at least one fundamental frequency and the amplitudes associated with the music stem data for the time segments of the music stem data.
Aspect 16. The non-transitory computer readable storage medium of Aspect 15, wherein the instructions cause the one or more processors to perform operations further comprising: receiving second music stem data associated with the song data, wherein the second music stem data includes second track data different from the first track data, and wherein the second track data is extracted from the music stem data using the machine learning source separation model; processing the second music stem data to estimate at least one fundamental frequency associated with the second music stem data; processing the second music stem data to calculate amplitudes associated with the second music stem data for the time segments of the music stem data; and facilitating generation of the visual representation of using the amplitudes associated with the second music stem data with the amplitudes associated with the music stem data to generate a compact visual representation of the plurality of data tracks of the song data in detailed windows of a user interface.
Aspect 17. The non-transitory computer readable storage medium of Aspect 16, wherein the detailed windows have aligned timing indicators.
Aspect 18. The non-transitory computer readable storage medium of Aspect 17, wherein the aligned timing indicators are generated automatically by a machine learning tempo identification model from the song data to represent a time signature associated with the music stem data. In some aspects, the alignment timing indicators can be generated from the stem data.
Aspect 19. The non-transitory computer readable storage medium of Aspect 17, wherein the music stem data is associated with a first musical instrument, and wherein the second music stem data is associated with one or more percussion instruments.
Aspect 20. The non-transitory computer readable storage medium of Aspect 16, wherein the music stem data is associated with a first musical instrument, and wherein the second music stem data is associated with a plurality of instruments; and processing the music stem data to estimate at the least one fundamental frequency identifies a first fundamental frequency associated with a first set of the plurality of instruments and a second fundamental frequency associated with a second set of the plurality of instruments.
Aspect 21. The computer-implemented method of Aspect 7, wherein the compact visual representation includes a double line representing the first fundamental frequency, the second fundamental frequency, and the amplitudes for the second music stem data.
Aspect 22. The computer-implemented method of Aspect 3, further comprising: receiving third music stem data associated with the song data, wherein the third music stem data includes third track data different from the first track data and the second track data, and wherein the third track data is extracted from the music stem data using the machine learning source separation model; dynamically identifying the third music stem data as associated with percussion instruments; processing the third music stem data using a drum transcription model; generating a set of discrete percussion indicators aligned with a timing of the music stem data.
Aspect 23. The computer-implemented method of Aspect 22, wherein the compact visual representation includes the set of discrete percussion indicators at a top or a bottom of a detail window including representations for the music stem data and the second music stem data.
Aspect 24. The computer-implemented method of Aspect 22, further comprising: processing the third music stem data using a high pass filter to generate high frequency percussion data; processing the high frequency percussion data to calculate amplitudes associated with the high frequency percussion data for time segments of the music stem data.
Aspect 25. The computer-implemented method of Aspect 24, wherein the compact visual representation includes discrete percussion indicators for the high frequency percussion data at a top of a detail window.
Aspect 26. The computer-implemented method of Aspect 22, further comprising: processing the third music stem data using a low pass filter to generate low frequency percussion data; processing the low frequency percussion data to calculate amplitudes associated with the low frequency percussion data for time segments of the music stem data.
Aspect 27. The computer-implemented method of Aspect 26, wherein the compact visual representation includes discrete percussion indicators for the low frequency percussion data at a bottom of a detail window.
Aspect 28. The computer-implemented method of Aspect 1, wherein the method is performed by a cloud server system to facilitate display of the compact visual representation on a user device.
Aspect 29. The computer-implemented method of Aspect 1, wherein the method is performed by a mobile computing device after receiving the song data from a network server.
Aspect 30. A computing device comprising a display screen, the computing device being configured to display on the screen a compact representation of a song, the compact representation of the song including a representation of a stem of the song generated by processing song data for the song using a machine learning source separation model to generate the stem, processing the stem to determine one or more frequencies and associated amplitudes for the stem at time periods from a start to an end of the song, and dynamically generating the compact representation of the song including a stem visualization within a detail window of a user interface presented on the screen.
Aspect 31. The computing device of Aspect 30, wherein the compact representation of the song further includes representations for a plurality of stems of the song generated by processing the song data using the machine learning source separation model and processing the plurality of the stems to generate the compact representation including relative amplitude lines for each stem of the plurality of stems in the detail window.
Aspect 32. The computing device of Aspect 30, wherein the compact representation of the song further includes a representation of a percussion stem of the song generated by processing the song data using the machine learning source separation model and processing the percussion stem to generate discrete indicators associated with the percussion stem at the time periods from the start to the end of the song.
Aspect 33. The computing device of Aspect 30, wherein the computing device is further configured to display on the screen a compact representation of a second song within the detail window adjacent to the compact representation of the song, wherein the compact representation of the second song is generated by the machine learning source separation model and processed to match a timing of the second song to a timing of the song.
Aspect 34. A computing device comprising a display screen, the computing device being configured to display on the screen a compact representation of a song, the compact representation of the song including a representation of a percussion stem of the song generated by processing song data for the song using a machine learning source separation model to generate the percussion stem, processing the percussion stem using one or more of a drum transcription model, a filter, and an amplitude envelope detector to generate discrete indicators associated with the percussion stem, and dynamically generating the compact representation of the song including the discrete indicators within a detail window of a user interface presented on the screen.
Aspect 35. A computer-implemented method comprising: receiving an indication of a first song selection from a song data listing; receiving processed stem data associated with the first song selection, wherein the processed stem data is generated from first song music data processed by a machine learning source separation model; dynamically generating first song frequency indicators and first song amplitude indicators from the processed stem data for times from a start to an end of the first song music data; and dynamically displaying the first song amplitude indicators in a timing window of a user interface.
Aspect 36. The computer-implemented method of Aspect 35, further comprising: receiving indication of a second song selection from a song data listing; receiving second processed stem data associated with the second song selection, wherein the second processed stem data is generated from second song music data processed by the machine learning source separation model; dynamically generating second song frequency indicators and second song amplitude indicators adjacent to the first song amplitude indicators in the timing window of the user interface.
Aspect 37. The computer-implemented method of Aspect 36, wherein the processed stem data includes stem data for a fixed set of stems including a vocal stem, one or more instrumental stems, and a percussion stem.
Aspect 38. The computer-implemented method of Aspect 36, further comprising: dynamically generating second song amplitude indicators adjacent to the first song amplitude indicators in the timing window of the user interface; receiving a synchronize input associated with the first song selection; and adjusting a tempo associated with the first song selection to match a tempo associated with the second song selection; and shifting relative positions of the first song amplitude indicators in the timing window of the user interface based on adjustment of the tempo associated with the first song.
Aspect 39. The computer-implemented method of Aspect 35, further comprising dynamically displaying the first song amplitude indicators in the timing window of a user interface as an overview of an entirety of the first song selection; and dynamically displaying an enlarged portion of the first song amplitude indicators around a selected time position for the first song selection.
Aspect 40. The computer-implemented method of Aspect 35, further comprising: receiving a selection of a first time portion of the first song selection; automatically generating a loop of the first time portion of the first song selection; and dynamically displaying looped portion amplitude indicators in the timing window matching the loop of the first time portion of the first song selection.
Aspect 41. The computer-implemented method of Aspect 35, wherein the first song frequency indicators comprise a vertical placement within a stem lane representing frequencies of music at a time within the timing window.
Aspect 42. The computer-implemented method of Aspect 35, wherein the first song amplitude indicators comprise one or more of a line color intensity, a line color, or a line thickness at the time within the timing window.
Aspect 43. The computer-implemented method of Aspect 35, wherein the first song frequency indicators comprise a plurality of lines at different vertical placements within a stem lane, wherein each line of the plurality of lines represents a different frequency of a chord at the time within the timing window.
Aspect 44A. The computer-implemented method of Aspect 35, further comprising: dynamically identifying a percussion stem from the processed stem data; processing the percussion stem using a drum transcription model to generate discrete percussion indicators; and dynamically displaying the discrete percussion indicators with the first song amplitude indicators in the timing window of the user interface.
Aspect 44B. The computer-implemented method of Aspect 35, wherein the stem data comprises a percussion stem, a bass stem, a vocal stem, and an other stem; and wherein dynamically displaying the first song amplitude indicators in the timing window includes displaying each stem within a separate swim lane of the timing window with the amplitude of each stem represented by a stem waveform and a frequency indicator of each stem represented by a vertical position of the waveform within each corresponding swim lane.
Aspect 45. The computer-implemented method of Aspect 35, further comprising: dynamically identifying a percussion stem from the processed stem data; processing the percussion stem using a drum transcription model to generate a plurality of percussion indicators.
Aspect 45. The computer-implemented method of Aspect 44, wherein the plurality of percussion indicators include snare indicators and kick indicators.
Aspect 46. The computer-implemented method of Aspect 44, wherein the plurality of percussion indicators are each individually identified by a separate color within a shared percussion lane in the timing window.
Aspect 47. The computer-implemented method of Aspect 44, wherein the plurality of percussion indicators comprise one-sided amplitude indicators extending from a border of the timing window.
Aspect 48. The computer-implemented method of Aspect 44, wherein the plurality of percussion indicators comprise two-sided amplitude indicators floating within a shared percussion lane of the timing window.
Aspect 49. A non-transitory computer readable storage medium comprising instructions that, when executed by one or more processors of a device, cause the device to perform operations according to any aspect above.
Aspect 50. A device comprising means for performing any operation described above.
Aspect 51. A system comprising: a memory configured to store data in accordance with any aspect above; and one or more processors coupled to the memory and configured to perform operations in accordance with any aspect above.

What is claimed is:

1. A computer-implemented method comprising:
receiving an indication of a first song selection from a song data listing;
receiving processed stem data associated with the first song selection, wherein the processed stem data is generated from first song music data processed by a machine learning source separation model;
dynamically generating first song frequency indicators and first song amplitude indicators from the processed stem data for times from a start to an end of the first song music data; and
dynamically displaying the first song amplitude indicators in a timing window of a user interface.

2. The computer-implemented method of claim 1, further comprising:
receiving indication of a second song selection from a song data listing;
receiving second processed stem data associated with the second song selection, wherein the second processed stem data is generated from second song music data processed by the machine learning source separation model;
dynamically generating second song frequency indicators and second song amplitude indicators adjacent to the first song amplitude indicators in the timing window of the user interface.

3. The computer-implemented method of claim 1, wherein the first song frequency indicators comprise a vertical placement within a stem lane representing frequencies of music at a time within the timing window.

4. The computer-implemented method of claim 1, wherein the first song amplitude indicators comprise one or more of a line color intensity, a line color, or a line thickness at a time within the timing window.

5. The computer-implemented method of claim 1, wherein the first song frequency indicators comprise a plurality of lines at different vertical placements within a stem lane, wherein each line of the plurality of lines represents a different frequency of a chord at a time within the timing window.

6. The computer-implemented method of claim 1, wherein the stem data comprises a percussion stem, a bass stem, a vocal stem, and an other stem; and
wherein dynamically displaying the first song amplitude indicators in the timing window includes displaying each stem within a separate stem lane of the timing window with the amplitude of each stem represented by a stem waveform and a frequency indicator of each stem represented by a vertical position of the waveform within each corresponding stem lane.

7. The computer-implemented method of claim 1, further comprising:
dynamically identifying a percussion stem from the processed stem data; processing the percussion stem using a drum transcription model to generate a plurality of percussion indicators, wherein the plurality of percussion indicators include snare indicators and kick indicators, and wherein the plurality of percussion indicators are each individually identified by a separate color within a shared percussion lane in the timing window.

8. A system comprising:
a memory configured to store song listing data; and
one or more processors coupled to the memory and configured for operations including:
receiving an indication of a first song selection from the song listing data;
receiving processed stem data associated with the first song selection, wherein the processed stem data is generated from first song music data processed by a machine learning source separation model;
dynamically generating first song frequency indicators and first song amplitude indicators from the processed stem data for times from a start to an end of the first song music data; and
dynamically displaying the first song amplitude indicators in a timing window of a user interface.

9. The system of claim 8, wherein the one or more processors are configured for operations further comprising:
receiving indication of a second song selection from a song data listing;
receiving second processed stem data associated with the second song selection, wherein the second processed stem data is generated from second song music data processed by the machine learning source separation model;
dynamically generating second song frequency indicators and second song amplitude indicators adjacent to the first song amplitude indicators in the timing window of the user interface.

10. The system of claim 8, wherein the first song frequency indicators comprise a vertical placement within a stem lane representing frequencies of music at a time within the timing window.

11. The system of claim 8, wherein the first song amplitude indicators comprise one or more of a line color intensity, a line color, or a line thickness at a time within the timing window.

12. The system of claim 8, wherein the first song frequency indicators comprise a plurality of lines at different vertical placements within a stem lane, wherein each line of the plurality of lines represents a different frequency of a chord at a time within the timing window.

13. The system of claim 8, wherein the one or more processors are configured for operations further comprising:
dynamically identifying a percussion stem from the processed stem data;
processing the percussion stem using a drum transcription model to generate discrete percussion indicators; and
dynamically displaying the discrete percussion indicators with the first song amplitude indicators in the timing window of the user interface.

14. The system of claim 8, wherein the one or more processors are configured for operations further comprising:
dynamically identifying a percussion stem from the processed stem data; processing the percussion stem using a drum transcription model to generate a plurality of percussion indicators, wherein the plurality of percussion indicators include snare indicators and kick indicators, and wherein the plurality of percussion indicators are each individually identified by a separate color within a shared percussion lane in the timing window.

15. A non-transitory computer readable storage medium comprising instructions that, when executed by one or more processors of a device, cause the device to perform operations comprising:
receiving an indication of a first song selection from a song data listing;
receiving processed stem data associated with the first song selection, wherein the processed stem data is generated from first song music data processed by a machine learning source separation model;
dynamically generating first song frequency indicators and first song amplitude indicators from the processed stem data for times from a start to an end of the first song music data; and
dynamically displaying the first song amplitude indicators in a timing window of a user interface.

16. The non-transitory computer readable storage medium of claim 15, wherein the instructions cause the device to perform operations further comprising:
receiving indication of a second song selection from a song data listing;
receiving second processed stem data associated with the second song selection, wherein the second processed stem data is generated from second song music data processed by the machine learning source separation model;
dynamically generating second song frequency indicators and second song amplitude indicators adjacent to the first song amplitude indicators in the timing window of the user interface.

17. The non-transitory computer readable storage medium of claim 15, wherein the first song frequency indicators comprise a vertical placement within a stem lane representing frequencies of music at a time within the timing window.

18. The non-transitory computer readable storage medium of claim 15, wherein the first song amplitude indicators comprise one or more of a line color intensity, a line color, or a line thickness at a time within the timing window.

19. The non-transitory computer readable storage medium of claim 15, wherein the stem data comprises a percussion stem, a bass stem, a vocal stem, and an other stem; and
wherein dynamically displaying the first song amplitude indicators in the timing window includes displaying each stem within a separate stem lane of the timing window with the amplitude of each stem represented by a stem waveform and a frequency indicator of each stem represented by a vertical position of the waveform within each corresponding stem lane.

20. The non-transitory computer readable storage medium of claim 15, wherein the instructions further configure the device for operations comprising:
dynamically identifying a percussion stem from the processed stem data; processing the percussion stem using a drum transcription model to generate a plurality of percussion indicators, wherein the plurality of percussion indicators include snare indicators and kick indicators, and wherein the plurality of percussion indicators are each individually identified by a separate color within a shared percussion lane in the timing window.
